(19) United States
(12) Patent Application Publication
(10) Pub. No.: US 2022/0213369 A1
(43) Pub. Date: Jul. 7, 2022

(54) FLUORINATED ALKENE SYSTEMS

(71) Applicant: THE CHEMOURS COMPANY FC, LLC, WILMINGTON, DE (US)

(72) Inventors: VIACHESLAV A. PETROV, HOCKESSIN, DE (US); KONSTANTINOS KONTOMARIS, WILMINGTON, DE (US); LUKE DAVID SIMONI, WILMINGTON, DE (US)

(73) Assignee: THE CHEMOURS COMPANY FC, LLC, WILMINGTON, DE (US)

(21) Appl. No.: 17/604,073

(22) PCT Filed: Apr. 17, 2020
(86) PCT No.: PCT/US2020/028675

§ 371 Date: Oct. 15, 2021

Related U.S. Application Data
(60) Provisional application No. 62/835,703, filed on Apr. 18, 2019.

(51) Int. Cl. C09K 5/04

(52) U.S. Cl. CPC C09K 5/045

(57) ABSTRACT

A process for transferring heat including providing an article and contacting the article with a heat transfer media. The heat transfer media includes a composition formed by the process of, contacting a compound of formula (1), R_{f}CH═CHF, with a fluorinated ethylene compound of formula (2), CX₁X₂═CX₃X₄ in the presence of a Lewis acid catalyst. In the compound of formula (1) R_{f} is a C₁-C₁₀ perfluorinated alkyl group. In the compound of formula (2) X₁, X₂, X₃, and X₄ are each independently H, Cl, or F and at least one of X₁, X₂, X₃, and X₄ is F. The resulting composition comprises a compound of formula (3), R_{f}CF₃(CX₅X₆CX₇X₈)ₙCH═CHCX₉X₁₀CX₁₁X₁₂F. In the compound of formula (3), X₅, X₆, X₇, X₈, X₉, X₁₀, X₁₁, and X₁₂ are each independently H, Cl, or F, and n is an integer of 0 or 1.

This Application claims the benefit of U.S. Application No. 62/835,703, filed Apr. 18, 2019. The disclosure of Application No. 62/835,703 is hereby incorporated by reference.

### FIELD

The present invention is directed to the use of fluorinated alkene compounds, such as, heat transfer materials.

### BACKGROUND

There is interest in low temperature heat utilization (i.e., heat at temperatures lower than about 300° C.). Such heat may be extracted from various commercial, industrial or natural sources. Elevation of the temperature of available heat through high temperature mechanical compression heat pumps (HTHPs) to meet heating requirements and conversion of the available heat to mechanical or electrical power through Organic Rankine Cycles (ORCs) are two promising approaches for the utilization of low temperature heat.

ORCs and HTHPs require the use of working fluids. Working fluids with high global warming potentials (GWPs) currently in common use for HTHPs and ORCs (e.g. HFC-245fa) have been under review and there is a need for more environmentally sustainable working fluids for HTHPs and ORCs. More specifically, there is a need for low GWP working fluids with boiling points higher than about 50 degrees Celsius (hereinafter “° C.”) that are particularly suitable for conversion of heat available at temperatures approaching or exceeding 200° C. to power and for heating at temperatures approaching 200° C. from heat available at lower temperatures. Even more specifically, a low GWP working fluid with a boiling point close to that of ethanol (78.4° C.) could be advantageous as a replacement of ethanol in ORC systems for heavy duty vehicles (e.g., trucks) especially in Europe. Such a fluid could also be used as a solvent and as a heat transfer fluid for various applications, including immersion cooling and phase change cooling (e.g., of electronics, including data center cooling).

Fluoroalkenes, such as, F23E (C₂F₅CH═CHC₃F₇) can be prepared from F-heptene-3 starting material using a four-step preparation including sequential hydrogenation/dehydrofluorination process. However, this process is lengthy and is based on relatively expensive starting materials (F-heptene is made using the reaction of hexafluoropropene (HFP) and 2 moles of tetrafluoroethene (TFE)).

WO 2008/057513 describes a process for the preparation of internal dihydrofluoroolefins of the formula RCH═CHC₂F₅, comprising reacting a fluorinated olefin of the RCH═CHF, wherein R is selected from perfluoroalkyl groups having from one to ten carbon atoms, and the said alkyl group is either an n-alkyl chain, a sec-alkyl chain, or an iso-alkyl chain, in the liquid phase with tetrafluoroethylene, in the presence of an antimony pentafluoride (SbF₅) catalyst, removing the Lewis acid catalyst and isolating the dihydrofluoroolefin. The disclosure of WO 2008/057513 is hereby incorporated by reference.

### SUMMARY

The invention is summarized by various embodiments. One embodiment of the invention relates to a process for transferring heat, comprising:
providing an article;
contacting the article with a heat transfer media;
wherein the heat transfer media comprises a composition comprising a compound of formula (4),

R_{f}CF₃(CX₅X₆CX₇X₈)ₙCH═CHCX₉X₁₀CX₁₁X₁₂F (4)
wherein R_{f} is a C₁-C₁₀ perfluorinated alkyl group;
wherein X₅, X₆, X₇, X₈, X₉, X₁₀, X₁₁, and X₁₂ are each independently H, Cl, or F, n is an integer of 0 or 1; and
wherein the total number of F represented by X₅, X₆, X₇, X₈, X₉, X₁₀, X₁₁, and X₁₂ is at least two; and, optionally,
a co-compound including at least one of (E)-1,1,1,4,4,4-hexafluoro-2-butene, (HFO-1336mzz(E), CF₃CH═CHCF₃), (Z)-1,1,1,4,4,4-hexafluoro-2-butene, (HFO-1336mzz(Z), CF₃CH═CHCF₃), (E)-2,3-bis(trifluoromethyl)oxirane, (HFO-1336mzz(E)(Epoxide), CFCH(—O—)CHCF₃), (Z)-2,3-bis(trifluoromethyl)oxirane, (HFO-1336mzz(Z)(Epoxide), CFCH(—O—)CHCF₃), HFO-1234ze(Z), HFO-1234ye(E), HFO-1234ye(Z), HFO-1438mzz(E), HFO-1438mzz(Z), Heptafluoro-4-(trifluoromethyl)-pent-2-ene, ((HFO-153-10mzzy), (mixtures of HFO-153-10 isomers)), HFO-162-13mcyz, HFO-162-13mczy, (E)-1,3,4,4,4-pentafluoro-3-(trifluoromethyl)-1-butene, (HFO-1438ezy(E), CFH═CHCF(CF₃)₂), (Z)-1,3,4,4,4-pentafluoro-3-(trifluoromethyl)-1-butene, (HFO-1438ezy(Z), CFH═CHCF(CF₃)₂), HFO-1336ze(E), HFO-1336ze(Z), HFC-245fa, HFC-245ea, HFC-365mfc, HFC-43-10mee, (E)-1-chloro-3,3,3-trifluoro-propene, (HCFO-1233zd(E), CHCl═CHCF₃), (Z)-1-chloro-3,3,3-trifluoro-propene, (HCFO-1233zd(Z), CHCl═CHCF₃), HCFO-1224yd(E), HCFO-1224yd(Z), iso-pentane, n-pentane, cyclo-pentane, n-hexane, cyclohexane, heptane, methyl formate, dimethoxymethane, dimethoxyethane, propanal, methanol, ethanol, isopropanol, n-propanol, trans-1,2-dichloro-ethylene, cis-1,2 dichloro-ethylene, 1-methoxyheptafluoropropane (HFE-7000, CH₃OCF₂CF₂CF₃), methyl nonafluorobutyl ether (HFE-7100, C₄F₉OCH₃), methoxy-nonafluorobutane (HFE-7100, C₄F₉OCH₃, CH₃O-3(CF₂)—CH₃), ethoxy-nonafluorobutane (HFE-7200, CH₃CH₂OCF₂CF₂CF₂CF₃, C₄F₉OC₂H₅), dodecafluoro-2-methylpentan-3-one (NOVEC-649 or Novec-1230; CF₃CF₂C(O)CF(CF₃)₂), 1,1,1,2,2,3,4,5,5,5-decafluoro-3-methoxy-4-(trifluoromethyl)-pentane (Novec-7300; C₇H₃F₁₃O; n-C₂F₅CF(OCH₃)CF(CF₃)₂), siloxanes, methyl perfluoroheptene ether, methoxy-perfluoro heptene ether or MPHE (HFX-110; C₇F₁₃(OCH₃)), MPPE (HFX-75), perfluorohept-2-ene/perfluorohept-3-ene (HFO-161-14myy/HFO-161-14mcyy, PFH, mixture, CF₃CF═CFCF₂CF₂CF₂CF₃/CF₃CF₂CF═CFCF₂CF₂CF₃), Perfluorohept-1-ene (FC-141-10cy, CF₂═CFCF₂CF₂CF₂CF₂CF₃), 1-bromo-1,2,3,3,3-pentafluoropropene, (R-1215ybB, CF₃CF═CFBr), 2-bromo-1,1,1,3,3-pentafluoro-2-propene, (R-1215xbB1, CF₃CBr═CF₂), (E)-1-Bromo-2,3,3,3-tetrafluoropropene, (HBFO-1224ydB(E), CF₃CF═CHBr), (Z)-1-Bromo-2,3,3,3-tetrafluoropropene, (HBFO-1224ydB(Z), CF₃CF═CHBr), 2-bromo-3,3,3-trifluoro-propene, (BFO-1233xfB, CF₃CBr═CH₂), trans-DCE/R-1336mzz(Z) mixtures, (suitable mixtures include those disclosed in WO2008/134061), (trans-DCE/methylperfluoroheptene ethers, (suitable mixtures include those disclosed in US 2012/0227764 A1)), (trans-DCE/HFC-43-10mee mixtures, (CHCl═CHCl/CF₃CHFCHFCF₂CF₃), (suitable mixtures include those disclosed in as disclosed in U.S. Pat. No. 5,196,137)), 2-bromo-2-chloro-1,1,1-trifluoroethane, (R-123B1, CHBrClCF₃), 2,3-dichloro-3,3-difluoropropene, (R-1232xf, CClF₂CCl═CH₂), (E)-1,1,4,4-tetrafluoro-2-butene, (R-1345mzz(E), CHF₂CH═CHCHF₂), 2-bromo-1,1-difluoroethane, (BDFE, CHF₂CH₂Br), 1-chloro-2,3,3,4,4,4-hexafluoro-1-butene, (HCFO-1326yd-Z, CF₃CF₂CF═CHCl), 1-chloro-2,3,3-trifluoropropene, (HCFO-1233yd-Z, CHF₂CF═CHCl), 2-(1,1,2,2-tetrafluoroethoxy)-1-fluoroethylene, (HFO-1345ezcEβγ, CFH═CHOCF₂CF₂H), 2,3,3,3-tetrafluoro-1-(1,1,2,2-tetrafluoroethoxy)prop-1-ene, (HFO-1438mzycEγδ, CF₃CF═CHOCF₂CF₂H), 1-(difluoromethoxy)-2,3,3,3-tetrafluoroprop-1-ene, (HFO-1336pzEαβ, CF₃CF═CHOCF₂H), 2,3,3-trifluoro-1-(trifluoromethoxy)prop-1-ene, (HFO-1336mzyEαβ, CHF₂CF═CHOCF₃), 1,1,1,2,2,5,5,6,6,6-decafluoro-3-hexene, (F22E, C₂F₅CH═CHC₂F₅), 1,1,1,2,2,3,3,4,4,7,7,8,8,9,9,10,10,10-octadecafluoro-5-decene, (F44E, C₄F₉CH═CHC₄F₉), or 1,1,1,2,3,4,4,5,5,5-decafluoropentane, (HFC-43-10mee, CF₃CHFCHFCF₂CF₃).

One embodiment of the invention relates to any combination of the foregoing embodiment wherein the compound of formula (4) includes 1,1,1,2,2,5,5,6,6,7,7,7-dodecafluorohept-2-ene, C₃F₇CH═CHC₂F₅(F23E).

One embodiment of the invention relates to any combination of the foregoing embodiments wherein the co-compound includes:
at least one of HFO-1336mzz(E), HFO-1336mzz(Z), HFO-1234ze(Z), HFO-1234ye(E), HFO-1234ye(Z), or ethanol.

Another embodiment of the invention relates to a process for transferring heat, comprising:
providing an article;
contacting the article with a heat transfer media;
wherein the heat transfer media comprises a composition formed by the process of,
contacting a compound of formula (1),

R_{f}CH═CHF (1)
wherein R_{f} is a C₁-C₁₀ perfluorinated alkyl group;
with a fluorinated ethylene compound of formula (2),

CX₁X₂═CX₃X₄ (2)
wherein X₁, X₂, X₃, and X₄ are each independently H, Cl, or F; and
   wherein at least one of X₁, X₂, X₃, or X₄ is F;
   in the presence of a Lewis acid catalyst in an amount sufficient to form a composition comprising a compound of formula (3),

R_{f}CF₃(CX₅X₆CX₇X₈)ₙCH═CHCX₉X₁₀CX₁₁X₁₂F (3)
wherein X₅, X₆, X₇, X₈, X₉, X₁₀, X₁₁, and X₁₂ are each independently H, Cl, or F, n is an integer of 0 or 1; and
wherein the total number of each of H, Cl, and F represented by X₅, X₆, X₇, X₈, X₉, X₁₀, X₁₁, and X₁₂ is the same as the total number of each of H, Cl, and F provided by the fluorinated ethylene compound of formula (2); and, optionally,
a co-compound including at least one of (E)-1,1,1,4,4,4-hexafluoro-2-butene, (HFO-1336mzz(E), CF₃CH═CHCF₃), (Z)-1,1,1,4,4,4-hexafluoro-2-butene, (HFO-1336mzz(Z), CF₃CH═CHCF₃), (E)-2,3-bis(trifluoromethyl)oxirane, (HFO-1336mzz(E)(Epoxide), CFCH(—O—)CHCF₃), (Z)-2,3-bis(trifluoromethyl)oxirane, (HFO-1336mzz(Z)(Epoxide), CFCH(—O—)CHCF₃), HFO-1234ze(Z), HFO-1234ye(E), HFO-1234ye(Z), HFO-1438mzz(E), HFO-1438mzz(Z), Heptafluoro-4-(trifluoromethyl)-pent-2-ene, ((HFO-153-10mzzy), (mixtures of HFO-153-10 isomers)), HFO-162-13mcyz, HFO-162-13mczy, (E)-1,3,4,4,4-pentafluoro-3-(trifluoromethyl)-1-butene, (HFO-1438ezy(E), CFH═CHCF(CF₃)₂), (Z)-1,3,4,4,4-pentafluoro-3-(trifluoromethyl)-1-butene, (HFO-1438ezy(Z), CFH═CHCF(CF₃)₂), HFO-1336ze(E), HFO-1336ze(Z), HFC-245fa, HFC-245ea, HFC-365mfc, HFC-43-10mee, (E)-1-chloro-3,3,3-trifluoro-propene, (HCFO-1233zd(E), CHCl═CHCF₃), (Z)-1-chloro-3,3,3-trifluoro-propene, (HCFO-1233zd(Z), CHCl═CHCF₃), HCFO-1224yd(E), HCFO-1224yd(Z), iso-pentane, n-pentane, cyclo-pentane, n-hexane, cyclohexane, heptane, methyl formate, dimethoxymethane, dimethoxyethane, propanal, methanol, ethanol, isopropanol, n-propanol, trans-1,2-dichloro-ethylene, cis-1,2 dichloro-ethylene, 1-methoxyheptafluoropropane (HFE-7000, CH₃OCF₂CF₂CF₃), methyl nonafluorobutyl ether (HFE-71 DA, C₄F₉OCH₃), methoxy-nonafluorobutane (HFE-7100, C₄F₉OCH₃, CH₃O-3(CF₂)—CH₃), ethoxy-nonafluorobutane (HFE-7200, CH₃CH₂OCF₂CF₂CF₂CF₃, C₄F₉OC₂H₅), dodecafluoro-2-methylpentan-3-one (NOVEC-649 or Novec-1230; CF₃CF₂C(O)CF(CF₃)₂), 1,1,1,2,2,3,4,5,5,5-decafluoro-3-methoxy-4-(trifluoromethyl)-pentane (Novec-7300; C₇H₃F₁₃O; n-C₂F₅CF(OCH₃)CF(CF₃)₂), siloxanes, methyl perfluoroheptene ether, methoxy-perfluoro heptene ether or MPHE (HFX-110; C₇F₁₃(OCH₃)), MPPE (HFX-75), perfluorohept-2-ene/perfluorohept-3-ene (HFO-161-14myy/HFO-161-14mcyy, PFH, mixture, CF₃CF═CFCF₂CF₂CF₂CF₃/CF₃CF₂CF═CFCF₂CF₂CF₃), Perfluorohept-1-ene (FC-141-10cy, CF₂═CFCF₂CF₂CF₂CF₂CF₃), 1-bromo-1,2,3,3,3-pentafluoropropene, (R-1215ybB, CF₃CF═CFBr), 2-bromo-1,1,1,3,3-pentafluoro-2-propene, (R-1215xbB1, CF₃CBr═CF₂), (E)-1-Bromo-2,3,3,3-tetrafluoropropene, (HBFO-1224ydB(E), CF₃CF═CHBr), (Z)-1-Bromo-2,3,3,3-tetrafluoropropene, (HBFO-1224ydB(Z), CF₃CF═CHBr), 2-bromo-3,3,3-trifluoro-propene, (BFO-1233xfB, CF₃CBr═CH₂), trans-DCE/R-1336mzz(Z) mixtures, (suitable mixtures include those disclosed in WO2008/134061), (trans-DCE/methylperfluoroheptene ethers, (suitable mixtures include those disclosed in US 2012/0227764 A1)), (trans-DCE/HFC-43-10mee mixtures, (CHCl═CHCl/CF₃CHFCHFCF₂CF₃), (suitable mixtures include those disclosed in as disclosed in U.S. Pat. No. 5,196,137)), 2-bromo-2-chloro-1,1,1-trifluoroethane, (R-123B1, CHBrClCF₃), 2,3-dichloro-3,3-difluoropropene, (R-1232xf, CClF₂CCl═CH₂), (E)-1,1,4,4-tetrafluoro-2-butene, (R-1345mzz(E), CHF₂CH═CHCHF₂), 2-bromo-1,1-difluoroethane, (BDFE, CHF₂CH₂Br), 1-chloro-2,3,3,4,4,4-hexafluoro-1-butene, (HCFO-1326yd-Z, CF₃CF₂CF═CHCl), 1-chloro-2,3,3-trifluoropropene, (HCFO-1233yd-Z, CHF₂CF═CHCl), 2-(1,1,2,2-tetrafluoroethoxy)-1-fluoroethylene, (HFO-1345ezcEβγ, CFH═CHOCF₂CF₂H), 2,3,3,3-tetrafluoro-1-(1,1,2,2-tetrafluoroethoxy)prop-1-ene, (HFO-1438mzycEγδ, CF₃CF═CHOCF₂CF₂H), 1-(difluoromethoxy)-2,3,3,3-tetrafluoroprop-1-ene, (HFO-1336pzEαβ, CF₃CF═CHOCF₂H), 2,3,3-trifluoro-1-(trifluoromethoxy)prop-1-ene, (HFO-1336mzyEαβ, CHF₂CF═CHOCF₃), 1,1,1,2,2,5,5,6,6,6-decafluoro-3-hexene, (F22E, C₂F₅CH═CHC₂F₅), 1,1,1,2,2,3,3,4,4,7,7,8,8,9,9,10,10,10-octadecafluoro-5-decene, (F44E, C₄F₉CH═CHC₄F₉), or 1,1,1,2,3,4,4,5,5,5-decafluoropentane, (HFC-43-10mee, CF₃CHFCHFCF₂CF₃).

One embodiment of the invention relates to any combination of the foregoing embodiments, wherein the compound of formula (3) includes 1,1,1,2,2,5,5,6,6,7,7,7-dodecafluorohept-2-ene, C₃F₇CH═CHC₂F₅(F23E).

One embodiment of the invention relates to any combination of the foregoing embodiments, wherein the co-compound includes:
at least one of HFO-1336mzz(E), HFO-1336mzz(Z), HFO-1234ze(Z), HFO-1234ye(E), HFO-1234ye(Z), or ethanol.

Another embodiment of the invention relates to a process for treating a surface, comprising:
providing a surface;
contacting the surface with a treatment composition;
wherein the surface includes a treatable material deposited thereon; and
wherein the treatment composition comprises a composition comprising 1,1,1,2,2,5,5,6,6,7,7,7-dodecafluorohept-2-ene, C3F7CH═CHC2F5 (F23E); and, optionally,
at least one of (E)-1,1,1,4,4,4-hexafluoro-2-butene, (HFO-1336mzz(E), CF₃CH═CHCF₃), (Z)-1,1,1,4,4,4-hexafluoro-2-butene, (HFO-1336mzz(Z), CF₃CH═CHCF₃), (E)-2,3-bis(trifluoromethyl)oxirane, (HFO-1336mzz(E)(Epoxide), CFCH(—O—)CHCF₃), (Z)-2,3-bis(trifluoromethyl)oxirane, (HFO-1336mzz(Z)(Epoxide), CFCH(—O—)CHCF₃), HFO-1234ze(Z), HFO-1234ye(E), HFO-1234ye(Z), HFO-1438mzz(E), HFO-1438mzz(Z), Heptafluoro-4-(trifluoromethyl)-pent-2-ene, ((HFO-153-10mzzy), (mixtures of HFO-153-10 isomers)), HFO-162-13mcyz, HFO-162-13mczy, (E)-1,3,4,4,4-pentafluoro-3-(trifluoromethyl)-1-butene, (HFO-1438ezy(E), CFH═CHCF(CF₃)₂), (Z)-1,3,4,4,4-pentafluoro-3-(trifluoromethyl)-1-butene, (HFO-1438ezy(Z), CFH═CHCF(CF₃)₂), HFO-1336ze(E), HFO-1336ze(Z), HFC-245fa, HFC-245ea, HFC-365mfc, HFC-43-10mee, (E)-1-chloro-3,3,3-trifluoro-propene, (HCFO-1233zd(E), CHCl═CHCF₃), (Z)-1-chloro-3,3,3-trifluoro-propene, (HCFO-1233zd(Z), CHCl═CHCF₃), HCFO-1224yd(E), HCFO-1224yd(Z), iso-pentane, n-pentane, cyclo-pentane, n-hexane, cyclohexane, heptane, methyl formate, dimethoxymethane, dimethoxyethane, propanal, methanol, ethanol, isopropanol, n-propanol, trans-1,2-dichloro-ethylene, cis-1,2 dichloro-ethylene, 1-methoxyheptafluoropropane (HFE-7000, CH₃OCF₂CF₂CF₃), methyl nonafluorobutyl ether (HFE-71 DA, C₄F₉OCH₃), methoxy-nonafluorobutane (HFE-7100, C₄F₉OCH₃, CH₃O-3(CF₂)—CH₃), ethoxy-nonafluorobutane (HFE-7200, CH₃CH₂OCF₂CF₂CF₂CF₃, C₄F₉OC₂H₅), dodecafluoro-2-methylpentan-3-one (NOVEC-649 or Novec-1230; CF₃CF₂C(O)CF(CF₃)₂), 1,1,1,2,2,3,4,5,5,5-decafluoro-3-methoxy-4-(trifluoromethyl)-pentane (Novec-7300; C₇H₃F₁₃O; n-C₂F₅CF(OCH₃)CF(CF₃)₂), siloxanes, methyl perfluoroheptene ether, methoxy-perfluoro heptene ether or MPHE (HFX-110; C₇F₁₃(OCH₃), MPPE (HFX-75), perfluorohept-2-ene/perfluorohept-3-ene (HFO-161-14myy/HFO-161-14mcyy, PFH, mixture, CF₃CF═CFCF₂CF₂CF₂CF₃/CF₃CF₂CF═CFCF₂CF₂CF₃), Perfluorohept-1-ene (FC-141-10cy, CF₂═CFCF₂CF₂CF₂CF₂CF₃), 1-bromo-1,2,3,3,3-pentafluoropropene, (R-1215ybB, CF₃CF═CFBr), 2-bromo-1,1,1,3,3-pentafluoro-2-propene, (R-1215xbB1, CF₃CBr═CF₂), (E)-1-Bromo-2,3,3,3-tetrafluoropropene, (HBFO-1224ydB(E), CF₃CF═CHBr), (Z)-1-Bromo-2,3,3,3-tetrafluoropropene, (HBFO-1224ydB(Z), CF₃CF═CHBr), 2-bromo-3,3,3-trifluoro-propene, (BFO-1233xfB, CF₃CBr═CH₂), trans-DCE/R-1336mzz(Z) mixtures, (suitable mixtures include those disclosed in WO2008/134061), (trans-DCE/methylperfluoroheptene ethers, (suitable mixtures include those disclosed in US 2012/0227764 A1)), (trans-DCE/HFC-43-10mee mixtures, (CHCl═CHCl/CF₃CHFCHFCF₂CF₃), (suitable mixtures include those disclosed in as disclosed in U.S. Pat. No. 5,196,137)), 2-bromo-2-chloro-1,1,1-trifluoroethane, (R-123B1, CHBrClCF₃), 2,3-dichloro-3,3-difluoropropene, (R-1232xf, CClF₂CCl═CH₂), (E)-1,1,4,4-tetrafluoro-2-butene, (R-1345mzz(E), CHF₂CH═CHCHF₂), 2-bromo-1,1-difluoroethane, (BDFE, CHF₂CH₂Br), 1-chloro-2,3,3,4,4,4-hexafluoro-1-butene, (HCFO-1326yd-Z, CF₃CF₂CF═CHCl), 1-chloro-2,3,3-trifluoropropene, (HCFO-1233yd-Z, CHF₂CF═CHCl), 2-(1,1,2,2-tetrafluoroethoxy)-1-fluoroethylene, (HFO-1345ezcEβγ, CFH═CHOCF₂CF₂H), 2,3,3,3-tetrafluoro-1-(1,1,2,2-tetrafluoroethoxy)prop-1-ene, (HFO-1438mzycEγδ, CF₃CF═CHOCF₂CF₂H), 1-(difluoromethoxy)-2,3,3,3-tetrafluoroprop-1-ene, (HFO-1336pzEαβ, CF₃CF═CHOCF₂H), 2,3,3-trifluoro-1-(trifluoromethoxy)prop-1-ene, (HFO-1336mzyEαβ, CHF₂CF═CHOCF₃), 1,1,1,2,2,5,5,6,6,6-decafluoro-3-hexene, (F22E, C₂F₅CH═CHC₂F₅), 1,1,1,2,2,3,3,4,4,7,7,8,8,9,9,10,10,10-octadecafluoro-5-decene, (F44E, C₄F₉CH═CHC₄F₉), or 1,1,1,2,3,4,4,5,5,5-decafluoropentane, (HFC-43-10mee, CF₃CHFCHFCF₂CF₃).

Another embodiment of the invention relates to a cooling, heating or power generation system, comprising:
an evaporator;
a condenser;
a compressor;
an expansion device; and
a heat transfer media;
wherein the heat transfer media comprises a composition comprising C3F7CH═CHC2F5 (F23E); and, optionally,
at least one of (E)-1,1,1,4,4,4-hexafluoro-2-butene, (HFO-1336mzz(E), CF3CH═CHCF3), (Z)-1,1,1,4,4,4-hexafluoro-2-butene, (HFO-1336mzz(Z), CF3CH═CHCF3), (E)-2,3-bis(trifluoromethyl)oxirane, (HFO-1336mzz(E)(Epoxide), CFCH(—O—)CHCF3), (Z)-2,3-bis(trifluoromethyl)oxirane, (HFO-1336mzz(Z)(Epoxide), CFCH(—O—)CHCF3), HFO-1234ze(Z), HFO-1234ye(E), HFO-1234ye(Z), HFO-1438mzz(E), HFO-1438mzz(Z), Heptafluoro-4-(trifluoromethyl)-pent-2-ene, ((HFO-153-10mzzy), (mixtures of HFO-153-10 isomers)), HFO-162-13mcyz, HFO-162-13mczy, (E)-1,3,4,4,4-pentafluoro-3-(trifluoromethyl)-1-butene, (HFO-1438ezy(E), CFH═CHCF(CF3)2), (Z)-1,3,4,4,4-pentafluoro-3-(trifluoromethyl)-1-butene, (HFO-1438ezy(Z), CFH═CHCF(CF3)2), HFO-1336ze(E), HFO-1336ze(Z), HFC-245fa, HFC-245ea, HFC-365mfc, HFC-43-10mee, (E)-1-chloro-3,3,3-trifluoro-propene, (HCFO-1233zd(E), CHCl═CHCF3), (Z)-1-chloro-3,3,3-trifluoro-propene, (HCFO-1233zd(Z), CHCl═CHCF3), HCFO-1224yd(E), HCFO-1224yd(Z), iso-pentane, n-pentane, cyclo-pentane, n-hexane, cyclohexane, heptane, methyl formate, dimethoxymethane, dimethoxyethane, propanal, methanol, ethanol, isopropanol, n-propanol, trans-1,2-dichloro-ethylene, cis-1,2 dichloro-ethylene, 1-methoxyheptafluoropropane (HFE-7000, CH3OCF2CF2CF3), methyl nonafluorobutyl ether (HFE-71 DA, C4F9OCH3), methoxy-nonafluorobutane (HFE-7100, C4F9OCH3, CH3O-3(CF2)-CH3), ethoxy-nonafluorobutane (HFE-7200, CH3CH2OCF2CF2CF2CF3, C4F9OC2H5), dodecafluoro-2-methylpentan-3-one (NOVEC-649 or Novec-1230; CF3CF2C(O)CF(CF3)₂), 1,1,1,2,2,3,4,5,5,5-decafluoro-3-methoxy-4-(trifluoromethyl)-pentane (Novec-7300; C7H3F13O; n-C2F5CF(OCH3)CF(CF3)2), siloxanes, methyl perfluoroheptene ether, methoxy-perfluoro heptene ether or MPHE (HFX-110; C7F13(OCH3)), MPPE (HFX-75), perfluorohept-2-ene/perfluorohept-3-ene (HFO-161-14myy/HFO-161-14mcyy, PFH, mixture, CF3CF═CFCF2CF2CF2CF3/CF3CF2CF═CFCF2CF2CF3), Perfluorohept-1-ene (FC-141-10cy, CF2═CFCF2CF2CF2CF2CF3), 1-bromo-1,2,3,3,3-pentafluoropropene, (R-1215ybB, CF3CF═CFBr), 2-bromo-1,1,1,3,3-pentafluoro-2-propene, (R-1215xbB1, CF3CBr═CF2), (E)-1-Bromo-2,3,3,3-tetrafluoropropene, (HBFO-1224ydB(E), CF3CF═CHBr), (Z)-1-Bromo-2,3,3,3-tetrafluoropropene, (HBFO-1224ydB(Z), CF3CF═CHBr), 2-bromo-3,3,3-trifluoro-propene, (BFO-1233xfB, CF3CBr═CH2), trans-DCE/R-1336mzz(Z) mixtures, (suitable mixtures include those disclosed in WO2008/134061), (trans-DCE/methylperfluoroheptene ethers, (suitable mixtures include those disclosed in US 2012/0227764 A1)), (trans-DCE/HFC-43-10mee mixtures, (CHCl═CHCl/CF3CHFCHFCF2CF3), (suitable mixtures include those disclosed in as disclosed in U.S. Pat. No. 5,196,137)), 2-bromo-2-chloro-1,1,1-trifluoroethane, (R-123B1, CHBrClCF3), 2,3-dichloro-3,3-difluoropropene, (R-1232xf, CClF2CCl═CH2), (E)-1,1,4,4-tetrafluoro-2-butene, (R-1345mzz(E), CHF2CH═CHCHF2), 2-bromo-1,1-difluoroethane, (BDFE, CHF2CH2Br), 1-chloro-2,3,3,4,4,4-hexafluoro-1-butene, (HCFO-1326yd-Z, CF3CF2CF═CHCl), 1-chloro-2,3,3-trifluoropropene, (HCFO-1233yd-Z, CHF2CF═CHCl), 2-(1,1,2,2-tetrafluoroethoxy)-1-fluoroethylene, (HFO-1345ezcEβγ, CFH═CHOCF2CF2H), 2,3,3,3-tetrafluoro-1-(1,1,2,2-tetrafluoroethoxy)prop-1-ene, (HFO-1438mzycEγδ, CF3CF═CHOCF2CF2H), 1-(difluoromethoxy)-2,3,3,3-tetrafluoroprop-1-ene, (HFO-1336pzEαβ, CF3CF═CHOCF2H), 2,3,3-trifluoro-1-(trifluoromethoxy)prop-1-ene, (HFO-1336mzyEαβ, CHF2CF═CHOCF3), 1,1,1,2,2,5,5,6,6,6-decafluoro-3-hexene, (F22E, C2F5CH═CHC2F5), 1,1,1,2,2,3,3,4,4,7,7,8,8,9,9,10,10,10-octadecafluoro-5-decene, (F44E, C4F9CH═CHC4F9), or 1,1,1,2,3,4,4,5,5,5-decafluoropentane, (HFC-43-10mee, CF3CHFCHFCF2CF3).

One embodiment of the invention relates to any combination of the foregoing embodiments, where the condenser is operated at a temperature higher than 100° C.

Another embodiment of the invention relates to a heat pipe system comprising:
a heat pipe having a working fluid therein;
wherein the working fluid comprises a composition comprising C3F7CH═CHC2F5 (F23E); and, optionally,
at least one of (E)-1,1,1,4,4,4-hexafluoro-2-butene, (HFO-1336mzz(E), CF3CH═CHCF3), (Z)-1,1,1,4,4,4-hexafluoro-2-butene, (HFO-1336mzz(Z), CF3CH═CHCF3), (E)-2,3-bis(trifluoromethyl)oxirane, (HFO-1336mzz(E)(Epoxide), CFCH(—O—)CHCF3), (Z)-2,3-bis(trifluoromethyl)oxirane, (HFO-1336mzz(Z)(Epoxide), CFCH(—O—)CHCF3), HFO-1234ze(Z), HFO-1234ye(E), HFO-1234ye(Z), HFO-1438mzz(E), HFO-1438mzz(Z), Heptafluoro-4-(trifluoromethyl)-pent-2-ene, ((HFO-153-10mzzy), (mixtures of HFO-153-10 isomers)), HFO-162-13mcyz, HFO-162-13mczy, (E)-1,3,4,4,4-pentafluoro-3-(trifluoromethyl)-1-butene, (HFO-1438ezy(E), CFH═CHCF(CF₃)₂), (Z)-1,3,4,4,4-pentafluoro-3-(trifluoromethyl)-1-butene, (HFO-1438ezy(Z), CFH═CHCF(CF₃)₂), HFO-1336ze(E), HFO-1336ze(Z), HFC-245fa, HFC-245ea, HFC-365mfc, HFC-43-10mee, (E)-1-chloro-3,3,3-trifluoro-propene, (HCFO-1233zd(E), CHCl═CHCF₃), (Z)-1-chloro-3,3,3-trifluoro-propene, (HCFO-1233zd(Z), CHCl═CHCF₃), HCFO-1224yd(E), HCFO-1224yd(Z), iso-pentane, n-pentane, cyclo-pentane, n-hexane, cyclohexane, heptane, methyl formate, dimethoxymethane, dimethoxyethane, propanal, methanol, ethanol, isopropanol, n-propanol, trans-1,2-dichloro-ethylene, cis-1,2 dichloro-ethylene, 1-methoxyheptafluoropropane (HFE-7000, CH₃OCF₂CF₂CF₃), methyl nonafluorobutyl ether (HFE-71DA, C₄F₉OCH₃), methoxy-nonafluorobutane (HFE-7100, C₄F₉OCH₃, CH₃O-3(CF₂)—CH₃), ethoxy-nonafluorobutane (HFE-7200, CH₃CH₂OCF₂CF₂CF₂CF₃, C₄F₉OC₂H₅), dodecafluoro-2-methylpentan-3-one (NOVEC-649 or Novec-1230; CF₃CF₂C(O)CF(CF₃)₂), 1,1,1,2,2,3,4,5,5,5-decafluoro-3-methoxy-4-(trifluoromethyl)-pentane (Novec-7300; C₇H₃F₁₃O; n-C₂F₅CF(OCH₃)CF(CF₃)₂), siloxanes, methyl perfluoroheptene ether, methoxy-perfluoro heptene ether or MPHE (HFX-110; C₇F₁₃(OCH₃), MPPE (HFX-75), perfluorohept-2-ene/perfluorohept-3-ene (HFO-161-14myy/HFO-161-14mcyy, PFH, mixture, CF₃CF═CFCF₂CF₂CF₂CF₃/CF₃CF₂CF═CFCF₂CF₂CF₃), Perfluorohept-1-ene (FC-141-10cy, CF₂═CFCF₂CF₂CF₂CF₂CF₃), 1-bromo-1,2,3,3,3-pentafluoropropene, (R-1215ybB, CF₃CF═CFBr), 2-bromo-1,1,1,3,3-pentafluoro-2-propene, (R-1215xbB1, CF₃CBr═CF₂), (E)-1-Bromo-2,3,3,3-tetrafluoropropene, (HBFO-1224ydB(E), CF₃CF═CHBr), (Z)-1-Bromo-2,3,3,3-tetrafluoropropene, (HBFO-1224ydB(Z), CF₃CF═CHBr), 2-bromo-3,3,3-trifluoro-propene, (BFO-1233xfB, CF₃CBr═CH₂), trans-DCE/R-1336mzz(Z) mixtures, (suitable mixtures include those disclosed in WO2008/134061), (trans-DCE/methylperfluoroheptene ethers, (suitable mixtures include those disclosed in US 2012/0227764 A1)), (trans-DCE/HFC-43-10mee mixtures, (CHCl═CHCl/CF₃CHFCHFCF₂CF₃), (suitable mixtures include those disclosed in as disclosed in U.S. Pat. No. 5,196,137)), 2-bromo-2-chloro-1,1,1-trifluoroethane, (R-123B1, CHBrClCF₃), 2,3-dichloro-3,3-difluoropropene, (R-1232xf, CClF₂CCl═CH₂), (E)-1,1,4,4-tetrafluoro-2-butene, (R-1345mzz(E), CHF₂CH═CHCHF₂), 2-bromo-1,1-difluoroethane, (BDFE, CHF₂CH₂Br), 1-chloro-2,3,3,4,4,4-hexafluoro-1-butene, (HCFO-1326yd-Z, CF₃CF₂CF═CHCl), 1-chloro-2,3,3-trifluoropropene, (HCFO-1233yd-Z, CHF₂CF═CHCl), 2-(1,1,2,2-tetrafluoroethoxy)-1-fluoroethylene, (HFO-1345ezcEβγ, CFH═CHOCF₂CF₂H), 2,3,3,3-tetrafluoro-1-(1,1,2,2-tetrafluoroethoxy)prop-1-ene, (HFO-1438mzycEγδ, CF₃CF═CHOCF₂CF₂H), 1-(difluoromethoxy)-2,3,3,3-tetrafluoroprop-1-ene, (HFO-1336pzEαβ, CF₃CF═CHOCF₂H), 2,3,3-trifluoro-1-(trifluoromethoxy)prop-1-ene, (HFO-1336mzyEαβ, CHF₂CF═CHOCF₃), 1,1,1,2,2,5,5,6,6,6-decafluoro-3-hexene, (F22E, C₂F₅CH═CHC₂F₅), 1,1,1,2,2,3,3,4,4,7,7,8,8,9,9,10,10,10-octadecafluoro-5-decene, (F44E, C₄F₉CH═CHC₄F₉), or 1,1,1,2,3,4,4,5,5,5-decafluoropentane, (HFC-43-10mee, CF₃CHFCHFCF₂CF₃).

Another embodiment of the invention relates to a process for recovering heat from a heat source and generating mechanical energy, comprising the steps of:
(a) passing a first working fluid in liquid phase through a heat exchanger or an evaporator, wherein said heat exchanger or said evaporator is in communication with said heat source that supplies said heat;
(b) removing at least a portion of said first working fluid in a vapor phase from said heat exchanger or said evaporator;
(c) passing said at least a portion of said first working fluid in vapor phase to an expander, wherein at least portion of said heat is converted into mechanical energy;
(d) passing said at least a portion of said first working fluid in vapor phase from said expander to a condenser, wherein said at least a portion of said first working fluid in vapor phase is condensed to a second working fluid in liquid phase;
(e) optionally, compressing and mixing said second working fluid in liquid phase with said first working fluid in liquid phase in Step (a); and
(f) optionally, repeating Steps (a) through (e), at least one time;
   wherein at least one of the first working fluid or the second working fluid comprises a composition comprising a compound of formula (4),

R_{f}CF₃(CX₅X₆CX₇X₈),CH═CHCX₉X₁₀CX₁₁X₁₂F (4)
wherein R_{f} is a C₁-C₁₀ perfluorinated alkyl group;
wherein X₅, X₆, X₇, X₈, X₉, X₁₀, X₁₁, and X₁₂ are each independently H, Cl, or F, n is an integer of 0 or 1; and
wherein the total number of F represented by X₅, X₆, X₇, X₈, X₉, X₁₀, X₁₁, and X₁₂ is at least two; and, optionally,
a co-compound including at least one of (E)-1,1,1,4,4,4-hexafluoro-2-butene, (HFO-1336mzz(E), CF₃CH═CHCF₃), (Z)-1,1,1,4,4,4-hexafluoro-2-butene, (HFO-1336mzz(Z), CF₃CH═CHCF₃), (E)-2,3-bis(trifluoromethyl)oxirane, (HFO-1336mzz(E)(Epoxide), CFCH(—O—)CHCF₃), (Z)-2,3-bis(trifluoromethyl)oxirane, (HFO-1336mzz(Z)(Epoxide), CFCH(—O—)CHCF₃), HFO-1234ze(Z), HFO-1234ye(E), HFO-1234ye(Z), HFO-1438mzz(E), HFO-1438mzz(Z), Heptafluoro-4-(trifluoromethyl)-pent-2-ene, ((HFO-153-10mzzy), (mixtures of HFO-153-10 isomers)), HFO-162-13mcyz, HFO-162-13mczy, (E)-1,3,4,4,4-pentafluoro-3-(trifluoromethyl)-1-butene, (HFO-1438ezy(E), CFH═CHCF(CF₃)₂), (Z)-1,3,4,4,4-pentafluoro-3-(trifluoromethyl)-1-butene, (HFO-1438ezy(Z), CFH═CHCF(CF₃)₂), HFO-1336ze(E), HFO-1336ze(Z), HFC-245fa, HFC-245ea, HFC-365mfc, HFC-43-10mee, (E)-1-chloro-3,3,3-trifluoro-propene, (HCFO-1233zd(E), CHCl═CHCF₃), (Z)-1-chloro-3,3,3-trifluoro-propene, (HCFO-1233zd(Z), CHCl═CHCF₃), HCFO-1224yd(E), HCFO-1224yd(Z), iso-pentane, n-pentane, cyclo-pentane, n-hexane, cyclohexane, heptane, methyl formate, dimethoxymethane, dimethoxyethane, propanal, methanol, ethanol, isopropanol, n-propanol, trans-1,2-dichloro-ethylene, cis-1,2 dichloro-ethylene, 1-methoxyheptafluoropropane (HFE-7000, CH₃OCF₂CF₂CF₃), methyl nonafluorobutyl ether (HFE-71DA, C₄F₉OCH₃), methoxy-nonafluorobutane (HFE-7100, C₄F₉OCH₃, CH₃O-3(CF₂)—CH₃), ethoxy-nonafluorobutane (HFE-7200, CH₃CH₂OCF₂CF₂CF₂CF₃, C₄F₉OC₂H₅), dodecafluoro-2-methylpentan-3-one (NOVEC-649 or Novec-1230; CF₃CF₂C(O)CF(CF₃)₂), 1,1,1,2,2,3,4,5,5,5-decafluoro-3-methoxy-4-(trifluoromethyl)-pentane (Novec-7300; C₇H₃F₁₃O; n-C₂F₅CF(OCH₃)CF(CF₃)₂), siloxanes, methyl perfluoroheptene ether, methoxy-perfluoro heptene ether or MPHE (HFX-110; C₇F₁₃(OCH₃)), MPPE (HFX-75), perfluorohept-2-ene/perfluorohept-3-ene (HFO-161-14myy/HFO-161-14mcyy, PFH, mixture, CF₃CF═CFCF₂CF₂CF₂CF₃/CF₃CF₂CF═CFCF₂CF₂CF₃), Perfluorohept-1-ene (FC-141-10cy, CF₂═CFCF₂CF₂CF₂CF₂CF₃), 1-bromo-1,2,3,3,3-pentafluoropropene, (R-1215ybB, CF₃CF═CFBr), 2-bromo-1,1,1,3,3-pentafluoro-2-propene, (R-1215xbB1, CF₃CBr═CF₂), (E)-1-Bromo-2,3,3,3-tetrafluoropropene, (HBFO-1224ydB(E), CF₃CF═CHBr), (Z)-1-Bromo-2,3,3,3-tetrafluoropropene, (HBFO-1224ydB(Z), CF₃CF═CHBr), 2-bromo-3,3,3-trifluoro-propene, (BFO-1233xfB, CF₃CBr═CH₂), trans-DCE/R-1336mzz(Z) mixtures, (suitable mixtures include those disclosed in WO2008/134061), (trans-DCE/methylperfluoroheptene ethers, (suitable mixtures include those disclosed in US 2012/0227764 A1)), (trans-DCE/HFC-43-10mee mixtures, (CHCl═CHCl/CF₃CHFCHFCF₂CF₃), (suitable mixtures include those disclosed in as disclosed in U.S. Pat. No. 5,196,137)), 2-bromo-2-chloro-1,1,1-trifluoroethane, (R-123B1, CHBrClCF₃), 2,3-dichloro-3,3-difluoropropene, (R-1232xf, CClF₂CCl═CH₂), (E)-1,1,4,4-tetrafluoro-2-butene, (R-1345mzz(E), CHF₂CH═CHCHF₂), 2-bromo-1,1-difluoroethane, (BDFE, CHF₂CH₂Br), 1-chloro-2,3,3,4,4,4-hexafluoro-1-butene, (HCFO-1326yd-Z, CF₃CF₂CF═CHCl), 1-chloro-2,3,3-trifluoropropene, (HCFO-1233yd-Z, CHF₂CF═CHCl), 2-(1,1,2,2-tetrafluoroethoxy)-1-fluoroethylene, (HFO-1345ezcEβγ, CFH═CHOCF₂CF₂H), 2,3,3,3-tetrafluoro-1-(1,1,2,2-tetrafluoroethoxy)prop-1-ene, (HFO-1438mzycEγδ, CF₃CF═CHOCF₂CF₂H), 1-(difluoromethoxy)-2,3,3,3-tetrafluoroprop-1-ene, (HFO-1336pzEαβ, CF₃CF═CHOCF₂H), 2,3,3-trifluoro-1-(trifluoromethoxy)prop-1-ene, (HFO-1336mzyEαβ, CHF₂CF═CHOCF₃), 1,1,1,2,2,5,5,6,6,6-decafluoro-3-hexene, (F22E, C₂F₅CH═CHC₂F₅), 1,1,1,2,2,3,3,4,4,7,7,8,8,9,9,10,10,10-octadecafluoro-5-decene, (F44E, C₄F₉CH═CHC₄F₉), or 1,1,1,2,3,4,4,5,5,5-decafluoropentane, (HFC-43-10mee, CF₃CHFCHFCF₂CF₃).

Another embodiment of the invention relates to a high temperature heat pump apparatus, said apparatus comprising (a) a first heat exchanger through which a working fluid flows and is heated; (b) a compressor in fluid communication with the first heat exchanger that compresses the heated working fluid to a higher pressure; (c) a second heat exchanger in fluid communication with the compressor through which the high pressure working fluid flows and is cooled; and (d) a pressure reduction device in fluid communication with the second heat exchanger wherein the pressure of the cooled working fluid is reduced and said pressure reduction device further being in fluid communication with the evaporator such that the working fluid then repeats flow through components (a), (b), (c) and (d) in a repeating cycle.

One embodiment of the invention relates to any combination of the foregoing embodiments, wherein at least one of the first working fluid or the second working fluid comprises a composition comprising a compound of formula (4),

R_{f}CF₃(CX₅X₆CX₇X₈)ₙCH═CHCX₉X₁₀CX₁₁X₁₂F (4)
wherein R_{f} is a C₁-C₁₀ perfluorinated alkyl group;
wherein X₅, X₆, X₇, X₈, X₉, X₁₀, X₁₁, and X₁₂ are each independently H, Cl, or F, n is an integer of 0 or 1; and
wherein the total number of F represented by X₅, X₆, X₇, X₈, X₉, X₁₀, X₁₁, and X₁₂ is at least two; and, optionally,
a co-compound including at least one of (E)-1,1,1,4,4,4-hexafluoro-2-butene, (HFO-1336mzz(E), CF₃CH═CHCF₃), (Z)-1,1,1,4,4,4-hexafluoro-2-butene, (HFO-1336mzz(Z), CF₃CH═CHCF₃), (E)-2,3-bis(trifluoromethyl)oxirane, (HFO-1336mzz(E)(Epoxide), CFCH(—O—)CHCF₃), (Z)-2,3-bis(trifluoromethyl)oxirane, (HFO-1336mzz(Z)(Epoxide), CFCH(—O—)CHCF₃), HFO-1234ze(Z), HFO-1234ye(E), HFO-1234ye(Z), HFO-1438mzz(E), HFO-1438mzz(Z), Heptafluoro-4-(trifluoromethyl)-pent-2-ene, ((HFO-153-10mzzy), (mixtures of HFO-153-10 isomers)), HFO-162-13mcyz, HFO-162-13mczy, (E)-1,3,4,4,4-pentafluoro-3-(trifluoromethyl)-1-butene, (HFO-1438ezy(E), CFH═CHCF(CF₃)₂), (Z)-1,3,4,4,4-pentafluoro-3-(trifluoromethyl)-1-butene, (HFO-1438ezy(Z), CFH═CHCF(CF₃)₂), HFO-1336ze(E), HFO-1336ze(Z), HFC-245fa, HFC-245ea, HFC-365mfc, HFC-43-10mee, (E)-1-chloro-3,3,3-trifluoro-propene, (HCFO-1233zd(E), CHCl═CHCF₃), (Z)-1-chloro-3,3,3-trifluoro-propene, (HCFO-1233zd(Z), CHCl═CHCF₃), HCFO-1224yd(E), HCFO-1224yd(Z), iso-pentane, n-pentane, cyclo-pentane, n-hexane, cyclohexane, heptane, methyl formate, dimethoxymethane, dimethoxyethane, propanal, methanol, ethanol, isopropanol, n-propanol, trans-1,2-dichloro-ethylene, cis-1,2 dichloro-ethylene, 1-methoxyheptafluoropropane (HFE-7000, CH₃OCF₂CF₂CF₃), methyl nonafluorobutyl ether (HFE-71DA, C₄F₉OCH₃), methoxy-nonafluorobutane (HFE-7100, C₄F₉OCH₃, CH₃O-3(CF₂)—CH₃), ethoxy-nonafluorobutane (HFE-7200, CH₃CH₂OCF₂CF₂CF₂CF₃, C₄F₉OC₂H₅), dodecafluoro-2-methylpentan-3-one (NOVEC-649 or Novec-1230; CF₃CF₂C(O)CF(CF₃)₂), 1,1,1,2,2,3,4,5,5,5-decafluoro-3-methoxy-4-(trifluoromethyl)-pentane (Novec-7300; C₇H₃F₁₃O; n-C₂F₅CF(OCH₃)CF(CF₃)₂), siloxanes, methyl perfluoroheptene ether, methoxy-perfluoro heptene ether or MPHE (HFX-110; C₇F₁₃(OCH₃)), MPPE (HFX-75), perfluorohept-2-ene/perfluorohept-3-ene (HFO-161-14myy/HFO-161-14mcyy, PFH, mixture, CF₃CF═CFCF₂CF₂CF₂CF₃/CF₃CF₂CF═CFCF₂CF₂CF₃), Perfluorohept-1-ene (FC-141-10cy, CF₂═CFCF₂CF₂CF₂CF₂CF₃), 1-bromo-1,2,3,3,3-pentafluoropropene, (R-1215ybB, CF₃CF═CFBr), 2-bromo-1,1,1,3,3-pentafluoro-2-propene, (R-1215xbB1, CF₃CBr═CF₂), (E)-1-Bromo-2,3,3,3-tetrafluoropropene, (HBFO-1224ydB(E), CF₃CF═CHBr), (Z)-1-Bromo-2,3,3,3-tetrafluoropropene, (HBFO-1224ydB(Z), CF₃CF═CHBr), 2-bromo-3,3,3-trifluoro-propene, (BFO-1233xfB, CF₃CBr═CH₂), trans-DCE/R-1336mzz(Z) mixtures, (suitable mixtures include those disclosed in WO2008/134061), (trans-DCE/methylperfluoroheptene ethers, (suitable mixtures include those disclosed in US 2012/0227764 A1)), (trans-DCE/HFC-43-10mee mixtures, (CHCl═CHCl/CF₃CHFCHFCF₂CF₃), (suitable mixtures include those disclosed in as disclosed in U.S. Pat. No. 5,196,137)), 2-bromo-2-chloro-1,1,1-trifluoroethane, (R-123B1, CHBrClCF₃), 2,3-dichloro-3,3-difluoropropene, (R-1232xf, CClF₂CCl═CH₂), (E)-1,1,4,4-tetrafluoro-2-butene, (R-1345mzz(E), CHF₂CH═CHCHF₂), 2-bromo-1,1-difluoroethane, (BDFE, CHF₂CH₂Br), 1-chloro-2,3,3,4,4,4-hexafluoro-1-butene, (HCFO-1326yd-Z, CF₃CF₂CF═CHCl), 1-chloro-2,3,3-trifluoropropene, (HCFO-1233yd-Z, CHF₂CF═CHCl), 2-(1,1,2,2-tetrafluoroethoxy)-1-fluoroethylene, (HFO-1345ezcEβγ, CFH═CHOCF₂CF₂H), 2,3,3,3-tetrafluoro-1-(1,1,2,2-tetrafluoroethoxy)prop-1-ene, (HFO-1438mzycEγδ, CF₃CF═CHOCF₂CF₂H), 1-(difluoromethoxy)-2,3,3,3-tetrafluoroprop-1-ene, (HFO-1336pzEαβ, CF₃CF═CHOCF₂H), 2,3,3-trifluoro-1-(trifluoromethoxy)prop-1-ene, (HFO-1336mzyEαβ, CHF₂CF═CHOCF₃), 1,1,1,2,2,5,5,6,6,6-decafluoro-3-hexene, (F22E, C₂F₅CH═CHC₂F₅), 1,1,1,2,2,3,3,4,4,7,7,8,8,9,9,10,10,10-octadecafluoro-5-decene, (F44E, C₄F₉CH═CHC₄F₉), or 1,1,1,2,3,4,4,5,5,5-decafluoropentane, (HFC-43-10mee, CF₃CHFCHFCF₂CF₃).

In an embodiment, a process for transferring heat includes providing an article and contacting the article with a heat transfer media. The heat transfer media includes a composition which includes a compound of formula (4), R_{f}CF₃(CX₅X₆CX₇X₈)ₙCH═CHCX₉X₁₀CX₁₁X₁₂F. In the compound of formula (4) R_{f} is a C₁-C₁₀ perfluorinated alkyl group, X₅, X₆, X₇, X₈, X₉, X₁₀, X₁₁, and X₁₂ are each independently H, Cl, or F, n is an integer of 0 or 1, and the total number of F represented by X₅, X₆, X₇, X₈, X₉, X₁₀, X₁₁, and X₁₂ is at least two.

The heat transfer media can additionally include one or more co-compounds.

In another embodiment, a process for transferring heat includes providing an article and contacting the article with a heat transfer media. The heat transfer media includes a composition formed by the process of contacting a compound of formula (1), R_{f}CH═CHF, with a fluorinated ethylene compound of formula (2), CX₁X₂═CX₃X₄. In the compound of formula (1), R_{f} is a C₁-C₁₀ perfluorinated alkyl group. In the compound of formula (2), X₁, X₂, X₃, and X₄ are each independently H, Cl, or F and at least one of X₁, X₂, X₃, or X₄ is F. The contacting is performed in the presence of a Lewis acid catalyst in an amount sufficient to form a composition comprising a compound of formula (3), R_{f}CF₃(CX₅X₆CX₇X₈)ₙCH═CHCX₉X₁₀CX₁₁X₁₂F. In the compound of formula (3), X₅, X₆, X₇, X₈, X₉, X₁₀, X₁₁, and X₁₂ are each independently H, Cl, or F and the total number of each of H, Cl, and F represented by X₅, X₆, X₇, X₈, X₉, X₁₀, X₁₁, and X₁₂ is the same as the total number of each of H, Cl, and F provided by the fluorinated ethylene compound of formula (2).

The heat transfer media can additionally include one or more co-compounds.

In another embodiment, a process for treating a surface includes providing a surface and contacting the surface with a treatment composition. The surface includes a treatable material deposited thereon. The treatment composition comprises a composition comprising 1,1,1,2,2,5,5,6,6,7,7,7-dodecafluorohept-2-ene, C₃F₇CH═CHC₂F₅(F23E).

The treatment composition can additionally include one or more co-compounds.

In another embodiment, a refrigeration system, including an evaporator, a condenser, a compressor, an expansion device, and a heat transfer media. The heat transfer media comprises a composition comprising 1,1,1,2,2,5,5,6,6,7,7,7-dodecafluorohept-2-ene, C₃F₇CH═CHC₂F₅(F23E).

The treatment composition can additionally include one or more co-compounds.

In another embodiment, a heat pipe system including a heat pipe having a working fluid therein. The working fluid comprises a composition comprising 1,1,1,2,2,5,5,6,6,7,7,7-dodecafluorohept-2-ene, C₃F₇CH═CHC₂F₅(F23E).

The working fluid can additionally include one or more co-compounds.

In another embodiment, a process for transferring heat, including providing an article and contacting the article with a heat transfer media. The heat transfer media comprises a composition comprising a compound of formula (4), R_{f}CF₃(CX₅X₆CX₇X₈)ₙCH═CHCX₉X₁₀CX₁₁X₁₂F (4). In the compound of formula (4), R_{f} is a C₁-C₁₀ perfluorinated alkyl group, X₅, X₆, X₇, X₈, X₉, X₁₀, X₁₁, and X₁₂ are each independently H, Cl, or F, n is an integer of 0 or 1, and the total number of F represented by X₅, X₆, X₇, X₈, X₉, X₁₀, X₁₁, and X₁₂ is at least two.

The heat transfer media can additionally include one or more co-compounds.

Suitable co-compounds useful in conjunction with the working fluids, treatment compounds, and heat transfer media described above include (E)-1,1,1,4,4,4-hexafluoro-2-butene, (HFO-1336mzz(E), CF₃CH═CHCF₃), (Z)-1,1,1,4,4,4-hexafluoro-2-butene, (HFO-1336mzz(Z), CF₃CH═CHCF₃), (E)-2,3-bis(trifluoromethyl)oxirane, (HFO-1336mzz(E)(Epoxide), CFCH(—O—)CHCF₃), (Z)-2,3-bis(trifluoromethyl)oxirane, (HFO-1336mzz(Z)(Epoxide), CFCH(—O—)CHCF₃), HFO-1234ze(Z), HFO-1234ye(E), HFO-1234ye(Z), HFO-1438mzz(E), HFO-1438mzz(Z), Heptafluoro-4-(trifluoromethyl)-pent-2-ene, ((HFO-153-10mzzy), (mixtures of HFO-153-10 isomers)), HFO-162-13mcyz, HFO-162-13mczy, (E)-1,3,4,4,4-pentafluoro-3-(trifluoromethyl)-1-butene, (HFO-1438ezy(E), CFH═CHCF(CF₃)₂), (Z)-1,3,4,4,4-pentafluoro-3-(trifluoromethyl)-1-butene, (HFO-1438ezy(Z), CFH═CHCF(CF₃)₂), HFO-1336ze(E), HFO-1336ze(Z), HFC-245fa, HFC-245ea, HFC-365mfc, HFC-43-10mee, (E)-1-chloro-3,3,3-trifluoro-propene, (HCFO-1233zd(E), CHCl═CHCF₃), (Z)-1-chloro-3,3,3-trifluoro-propene, (HCFO-1233zd(Z), CHCl═CHCF₃), HCFO-1224yd(E), HCFO-1224yd(Z), iso-pentane, n-pentane, cyclo-pentane, n-hexane, cyclohexane, heptane, methyl formate, dimethoxymethane, dimethoxyethane, propanal, methanol, ethanol, isopropanol, n-propanol, trans-1,2-dichloro-ethylene, cis-1,2 dichloro-ethylene, 1-methoxyheptafluoropropane (HFE-7000, CH₃OCF₂CF₂CF₃), methyl nonafluorobutyl ether (HFE-71 DA, C₄F₉OCH₃), methoxy-nonafluorobutane (HFE-7100, C₄F₉OCH₃, CH₃O-3(CF₂)—CH₃), ethoxy-nonafluorobutane (HFE-7200, CH₃CH₂OCF₂CF₂CF₂CF₃, C₄F₉OC₂H₅), dodecafluoro-2-methylpentan-3-one (NOVEC-649 or Novec-1230; CF₃CF₂C(O)CF(CF₃)₂), 1,1,1,2,2,3,4,5,5,5-decafluoro-3-methoxy-4-(trifluoromethyl)-pentane (Novec-7300; C₇H₃F₁₃O; n-C₂F₅CF(OCH₃)CF(CF₃)₂), siloxanes, methyl perfluoroheptene ether, methoxy-perfluoro heptene ether or MPHE (HFX-110; C₇F₁₃(OCH₃), MPPE (HFX-75), perfluorohept-2-ene/perfluorohept-3-ene (HFO-161-14myy/HFO-161-14mcyy, PFH, mixture, CF₃CF═CFCF₂CF₂CF₂CF₃/CF₃CF₂CF═CFCF₂CF₂CF₃), Perfluorohept-1-ene (FC-141-10cy, CF₂═CFCF₂CF₂CF₂CF₂CF₃), 1-bromo-1,2,3,3,3-pentafluoropropene, (R-1215ybB, CF₃CF═CFBr), 2-bromo-1,1,1,3,3-pentafluoro-2-propene, (R-1215xbB1, CF₃CBr═CF₂), (E)-1-Bromo-2,3,3,3-tetrafluoropropene, (HBFO-1224ydB(E), CF₃CF═CHBr), (Z)-1-Bromo-2,3,3,3-tetrafluoropropene, (HBFO-1224ydB(Z), CF₃CF═CHBr), 2-bromo-3,3,3-trifluoro-propene, (BFO-1233xfB, CF₃CBr═CH₂), trans-DCE/R-1336mzz(Z) mixtures, (suitable mixtures include those disclosed in WO2008/134061), (trans-DCE/methylperfluoroheptene ethers, (suitable mixtures include those disclosed in US 2012/0227764 A1)), (trans-DCE/HFC-43-10mee mixtures, (CHCl═CHCl/CF₃CHFCHFCF₂CF₃), (suitable mixtures include those disclosed in as disclosed in U.S. Pat. No. 5,196,137)), 2-bromo-2-chloro-1,1,1-trifluoroethane, (R-123B1, CHBrClCF₃), 2,3-dichloro-3,3-difluoropropene, (R-1232xf, CClF₂CCl═CH₂), (E)-1,1,4,4-tetrafluoro-2-butene, (R-1345mzz(E), CHF₂CH═CHCHF₂), 2-bromo-1,1-difluoroethane, (BDFE, CHF₂CH₂Br), 1-chloro-2,3,3,4,4,4-hexafluoro-1-butene, (HCFO-1326yd-Z, CF₃CF₂CF═CHCl), 1-chloro-2,3,3-trifluoropropene, (HCFO-1233yd-Z, CHF₂CF═CHCl), 2-(1,1,2,2-tetrafluoroethoxy)-1-fluoroethylene, (HFO-1345ezcEβγ, CFH═CHOCF₂CF₂H), 2,3,3,3-tetrafluoro-1-(1,1,2,2-tetrafluoroethoxy)prop-1-ene, (HFO-1438mzycEγδ, CF₃CF═CHOCF₂CF₂H), 1-(difluoromethoxy)-2,3,3,3-tetrafluoroprop-1-ene, (HFO-1336pzEαβ, CF₃CF═CHOCF₂H), 2,3,3-trifluoro-1-(trifluoromethoxy)prop-1-ene, (HFO-1336mzyEαβ, CHF₂CF═CHOCF₃), 1,1,1,2,2,5,5,6,6,6-decafluoro-3-hexene, (F22E, C₂F₅CH═CHC₂F₅), 1,1,1,2,2,3,3,4,4,7,7,8,8,9,9,10,10,10-octadecafluoro-5-decene, (F44E, C₄F₉CH═CHC₄F₉), or 1,1,1,2,3,4,4,5,5,5-decafluoropentane, (HFC-43-10mee, CF₃CHFCHFCF₂CF₃).

One embodiment of the invention relates to a composition formed by any combination of the foregoing methods.

The embodiments can be used alone or in combinations with each other. Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is a schematic diagram of one embodiment of a flooded evaporator heat pump apparatus according to the present invention.

FIG. 2 is a schematic diagram of one embodiment of a direct expansion heat pump apparatus according to the present invention.

FIG. 3 is a schematic diagram of a cascade heating pump system according to the present invention.

FIG. 4 is a schematic diagram of an Organic Rankine Cycle (ORC) according to the present invention.

FIG. 5 is graphical representation of ORC efficiency for compositions of E-F23E/R-1336mzzZ.

FIG. 6 is a graphical representation of ORC volumetric capacity for compositions of E-F23E/R-1336mzzZ.

FIG. 7 is a graphical representation of COPₕ for compositions comprising E-F23E/E-F12E

FIG. 8 is a graphical representation of COPₕ for compositions of E-F23E/R-1336mzzZ.

### DETAILED DESCRIPTION

Provided is a one-step synthesis for the production of fluorinated alkenes.

Embodiments of the present disclosure, for example, in comparison to concepts failing to include one or more of the features disclosed herein, provide a one-step synthesis for the production of fluorinated alkenes. More specifically, the present disclosure provides a one-step synthesis for the production of fluorinated alkenes having a perfluorinated alkyl chain.

The process may be conducted in any reactor suitable for a vapor phase fluorination reaction. The reactor is made of a material that is resistant to the reactants employed. The reactor may be constructed from materials which are resistant to the corrosive effects of hydrogen fluoride such as stainless steel, Hastelloy®, Inconel®, Monel®, gold or gold-lined or quartz. The reactions may be conducted batchwise, continuous, semi-continuous or combinations thereof. Suitable reactors include batch reactor vessels and tubular reactors.

In an embodiment a compound of formula (1),

R_{f}CH═CHF (1)
wherein R_{f} is a C₁-C₁₀ perfluorinated alkyl group;
is charged to a reactor, heated, and contacted, in the presence of a catalyst, with a fluorinated ethylene compound of formula (2),

CX₁X₂═CX₃X₄ (2)
wherein X₁, X₂, X₃, and X₄ are each independently H, Cl, or F; and
wherein at least one of X₁, X₂, X₃, or X₄ is F.

The temperature and pressure of the reactor are maintained at levels sufficient to effect, in the presence of a Lewis acid catalyst, the formation of a composition comprising a compound of formula (3),

R_{f}CF₃(CX₅X₆CX₇X₈)ₙCH═CHCX₉X₁₀CX₁₁X₁₂F (3)
wherein X₅, X₆, X₇, and X₈ are each independently H, Cl, or F, n is an integer of 0 or 1; and
wherein the total number of each of H, Cl, and F represented by X₅, X₆, X₇, X₈, X₉, X₁₀, X₁₁, and X₁₂ is the same as the total number of each of H, Cl, and F provided by the fluorinated ethylene compound of formula (2).

In some embodiments, the compound of formula (1) includes 1,3,3,3-tetrafluoro-1-propene, CF₃CH═CHF (1234ze). In one embodiment, the compound of formula (1) is CF₃CH═CHF (1234ze).

In some embodiments, the fluorinated ethylene of formula (2) includes at least one of tetrafluoro-ethene, CF₂═CF₂ (TFE) or CFCl═CF₂ (1-chloro-1,2,2-trifluoro-ethene), CF₂═CH₂ (1,1-difluoro-ethene), CH₂═CHF (1-fluoro-ethene), CF₂═CCl₂ (1,1-dichloro-2,2-difluoro-ethene), CFCl═CFCl (1,2-chloro-1,2-difluoro-ethene). In one embodiment, the fluorinated ethylene of formula (2) includes tetrafluoro-ethene, CF₂═CF₂ (TFE).

In one embodiment, the compound of formula (1) includes CF₃CH═CHF (1234ze) and the fluorinated ethylene of formula (2) includes CF₂═CF₂ (TFE). The reaction of CF₃CH═CHF (1234ze) and CF₂═CF₂ (TFE) may result in the formation of the composition including 1,1,1,4,4,5,5,5-octafluoropent-2-ene, CF₃CH═CHC₂F₅(F12E).

If desired, the 1,1,1,4,4,5,5,5-octafluoropent-2-ene may be isolated and optionally purified prior to use. Suitable uses of 1,1,1,4,4,5,5,5-octafluoropent-2-ene include, but are not limited to, a reactive intermediate, refrigerant, heat transfer fluid, and solvent.

In some embodiments, fluorinated ethylene of formula (2) may include a plurality of compounds of formula (2). The resulting compound of formula (3) may include a plurality of compounds of formula (3). In one embodiment, the fluorinated ethylene of formula (2) may include tetrafluoro-ethene, CF₂═CF₂ (TFE) and 1-chloro-1,2,2-trifluoro-ethene. In a further embodiment, the compound of formula (1) may include CF₃CH═CHF (1234ze).

The resulting compound of formula (3) may include 1,1,1,4,4,5,5,5-octafluoropent-2-ene, CF₃CH═CHC₂F₅(F12E), and 4-chloro-1,1,1,4,5,5,5-heptafluoropent-2-ene CF₃CH═CHCFClCF₃ 5-chloro-1,1,1,4,4,5,5-heptafluoropent-2-ene CF₃CH═CHCF₂CF₂Cl, 4,5-dichloro-1,1,1,4,5,5, hexafluoropent-2-ene, CF₃CH═CHCFClCF₂Cl, 1,1,1,5,5,5-hexafluoropent-2-ene CF₃CH═CHCH₂CF₃.

The molar ratio of a formula (2) compound to a formula (1) compound, which are contacted in accordance with the invention, can be used be control the composition and ratio of reaction products. In some embodiments, the compound of formula (2) and the compound of formula (1) are contacted in amounts resulting in a molar ratio of 0.01:1 to 5:1. In one embodiment, the compound of formula (2) and the compound of formula (1) are contacted in amounts resulting in a molar ratio of (2):(1) of 0.1:1 to 2:1. A contact molar ratio of about 1:1 can produce C5 compounds and a molar ratio of about 2:1 can product C7 compounds. While any desired ratio can be employed, a ratio of about 2:1 is useful. In one embodiment, the compound of formula (2) and the compound of formula (1) are contacted in amounts resulting in a molar ratio of (2):(1) of 1:1 to 2:1. In an embodiment, the compound of formula (2) is (TFE) and the compound of formula (1) is (1234ze).

The reaction conditions and stoichiometry may be selected to allow the compound of formula (3), such as, the 1,1,1,4,4,5,5,5-octafluoropent-2-ene, CF₃CH═CHC₂F₅(F12E) described above, to act as a reactive intermediate. In some embodiments, the fluorinated ethylene of formula (2) may be provided in a stoichiometric excess with respect to the amount of the compound of formula (1). In some embodiments, the excess of the compound of formula (2), such as (TFE), allows one or more additional units of the compound of formula (2) to react with the 1,1,1,4,4,5,5,5-octafluoropent-2-ene to form additional compounds of formula (3), having an extended carbon chain. In one embodiment, the composition comprising the compound of formula (3) may include 1,1,1,2,2,5,5,6,6,7,7,7-dodecafluorohept-2-ene, C₃F₇CH═CHC₂F₅(F23E).

The reaction is typically conducted in a closed system. In some embodiments, the Lewis acid is a strong Lewis acid. In one embodiment, the catalyst is, aluminum chloride (AlCl₃), or antimony pentafluoride (SbF₅), or aluminum chlorofluoride AlClₓF₃₋ₓ. In some embodiments, for aluminum-based catalyst x may be an integer from 1 to 3. In some embodiments, x may be 0.01 to 0.5. The amount of catalyst can range from about 0.1 to about 20 weight percent of the reaction mixture, in some cases about 1 to about 15 and in some cases about 5 to about 10 wt. %.

Additional suitable strong Lewis acids may be found in (Chemical Reviews, 1996, v.96, pp. 3269-3301; a list of strong Lewis acids is given on page 3271), which is hereby incorporated by reference. In some embodiments, the reaction mixture is heated to a sub-ambient or ambient temperature. In some embodiments, the reaction mixture is heated to a temperature of −50° C. to 50° C. In one embodiment, the reaction mixture is heated to a temperature of −50° C. to 25° C. In some embodiments, the reaction is performed at a reactor pressure of 0.1 pound per square inch gauged (psig) to 300 pounds per square inch gauged (psig). In some embodiments, the reaction is performed under autogenic pressure.

In some embodiments, the formation of the compound of formula (3) may be conducted in the presence of at least one of a solvent or a diluent; depending upon whether all components of a reaction mixture are soluble. In some embodiments, the solvent or diluent is a perfluorinated saturated compound. In some embodiments, the perfluorinated saturated compound may include perfluoropentane, perfluorohexane, cyclic dimer of hexafluoropropene, (mixture of perfluoro-1,2- and perfluoro-1,3-dimethylcyclobutanes), and combinations thereof or the product of the reaction can be used as a reaction media The amount of at least one solvent or diluent can range from about 10 to about 50 volume percent of the reaction vessel, about 15 to 40 and in some cases about 20 to 30 volume percent.

In one specific embodiment, the at least one diluent or solvent comprises a reaction product formed by contacting formulas (1) and (2). The reaction product diluent or solvent can be supplied to a reaction environment by recycling a portion of a recovered reaction product in a continuous method, leaving a residual portion of the reaction product in the reaction environment in a batch method, among other suitable techniques for delivering a diluent or solvent to a reaction environment.

In one embodiment of the invention, the reaction is conducted in an environment that is free or substantially free of compounds having OH groups. Examples of such OH containing compounds are hydrocarbon grease or oil, and solvents with OH group such as water or alcohol. By substantially free, it is meant that less than 50 ppm, less than 25 ppm and in some cases less than 10 ppm of OH containing compounds are present.

Compounds of formula (3) may be used in numerous applications for the transfer of heat, such as, heat transfer fluids or refrigerants. In one embodiment, the compounds of formula (3) (e.g., a reaction product mixture obtained by contacting formula (1) and (2) compounds), are used to transfer heat from an article. The article may be contacted with a heat transfer media including at least one compound of formula (3).

In an embodiment, the heat transfer process may involve providing an article and contacting the article with the heat transfer media. The heat transfer media includes a composition comprising a compound of formula (4),

R_{f}CF₃(CX₅X₆CX₇X₈),CH═CHCX₉X₁₀CX₁₁X₁₂F (4)
wherein R_{f} is a C₁-C₁₀ perfluorinated alkyl group, X₅, X₆, X₇ and X₈ are each independently H, Cl, or F, n is an integer of 0 or 1; and the total number of F represented by X₅, X₆, X₇, X₈, X₉, X₁₀, X₁₁, and X₁₂ is at least two. In some embodiments, the compound of formula (3) includes 1,1,1,2,2,5,5,6,6,7,7,7-dodecafluorohept-2-ene, C₃F₇CH═CHC₂F₅(F23E).

The heat transfer media composition may further optionally include one or more co-compounds including at least one of (E)-1,1,1,4,4,4-hexafluoro-2-butene, (HFO-1336mzz(E), CF₃CH═CHCF₃), (Z)-1,1,1,4,4,4-hexafluoro-2-butene, (HFO-1336mzz(Z), CF₃CH═CHCF₃), (E)-2,3-bis(trifluoromethyl)oxirane, (HFO-1336mzz(E)(Epoxide), CFCH(—O—)CHCF₃), (Z)-2,3-bis(trifluoromethyl)oxirane, (HFO-1336mzz(Z)(Epoxide), CFCH(—O—)CHCF₃), HFO-1234ze(Z), HFO-1234ye(E), HFO-1234ye(Z), HFO-1438mzz(E), HFO-1438mzz(Z), Heptafluoro-4-(trifluoromethyl)-pent-2-ene, ((HFO-153-10mzzy), (mixtures of HFO-153-10 isomers)), HFO-162-13mcyz, HFO-162-13mczy, (E)-1,3,4,4,4-pentafluoro-3-(trifluoromethyl)-1-butene, (HFO-1438ezy(E), CFH═CHCF(CF₃)₂), (Z)-1,3,4,4,4-pentafluoro-3-(trifluoromethyl)-1-butene, (HFO-1438ezy(Z), CFH═CHCF(CF₃)₂), HFO-1336ze(E), HFO-1336ze(Z), HFC-245fa, HFC-245ea, HFC-365mfc, HFC-43-10mee, (E)-1-chloro-3,3,3-trifluoro-propene, (HCFO-1233zd(E), CHCl═CHCF₃), (Z)-1-chloro-3,3,3-trifluoro-propene, (HCFO-1233zd(Z), CHCl═CHCF₃), HCFO-1224yd(E), HCFO-1224yd(Z), iso-pentane, n-pentane, cyclo-pentane, n-hexane, cyclohexane, heptane, methyl formate, dimethoxymethane, dimethoxyethane, propanal, methanol, ethanol, isopropanol, n-propanol, trans-1,2-dichloro-ethylene, cis-1,2 dichloro-ethylene, 1-methoxyheptafluoropropane (HFE-7000, CH₃OCF₂CF₂CF₃), methyl nonafluorobutyl ether (HFE-71 DA, C₄F₉OCH₃), methoxy-nonafluorobutane (HFE-7100, C₄F₉OCH₃, CH₃O-3(CF₂)—CH₃), ethoxy-nonafluorobutane (HFE-7200, CH₃CH₂OCF₂CF₂CF₂CF₃, C₄F₉OC₂H₅), dodecafluoro-2-methylpentan-3-one (NOVEC-649 or Novec-1230; CF₃CF₂C(O)CF(CF₃)₂), 1,1,1,2,2,3,4,5,5,5-decafluoro-3-methoxy-4-(trifluoromethyl)-pentane (Novec-7300; C₇H₃F₁₃O; n-C₂F₅CF(OCH₃)CF(CF₃)₂), siloxanes, methyl perfluoroheptene ether, methoxy-perfluoro heptene ether or MPHE (HFX-110; C₇F₁₃(OCH₃), MPPE (HFX-75), perfluorohept-2-ene/perfluorohept-3-ene (HFO-161-14myy/HFO-161-14mcyy, PFH, mixture, CF₃CF═CFCF₂CF₂CF₂CF₃/CF₃CF₂CF═CFCF₂CF₂CF₃), Perfluorohept-1-ene (FC-141-10cy, CF₂═CFCF₂CF₂CF₂CF₂CF₃), 1-bromo-1,2,3,3,3-pentafluoropropene, (R-1215ybB, CF₃CF═CFBr), 2-bromo-1,1,1,3,3-pentafluoro-2-propene, (R-1215xbB1, CF₃CBr═CF₂), (E)-1-Bromo-2,3,3,3-tetrafluoropropene, (HBFO-1224ydB(E), CF₃CF═CHBr), (Z)-1-Bromo-2,3,3,3-tetrafluoropropene, (HBFO-1224ydB(Z), CF₃CF═CHBr), 2-bromo-3,3,3-trifluoro-propene, (BFO-1233xfB, CF₃CBr═CH₂), trans-DCE/R-1336mzz(Z) mixtures, (suitable mixtures include those disclosed in WO2008/134061), (trans-DCE/methylperfluoroheptene ethers, (suitable mixtures include those disclosed in US 2012/0227764 A1)), (trans-DCE/HFC-43-10mee mixtures, (CHCl═CHCl/CF₃CHFCHFCF₂CF₃), (suitable mixtures include those disclosed in as disclosed in U.S. Pat. No. 5,196,137)), 2-bromo-2-chloro-1,1,1-trifluoroethane, (R-123B1, CHBrClCF₃), 2,3-dichloro-3,3-difluoropropene, (R-1232xf, CClF₂CCl═CH₂), (E)-1,1,4,4-tetrafluoro-2-butene, (R-1345mzz(E), CHF₂CH═CHCHF₂), 2-bromo-1,1-difluoroethane, (BDFE, CHF₂CH₂Br), 1-chloro-2,3,3,4,4,4-hexafluoro-1-butene, (HCFO-1326yd-Z, CF₃CF₂CF═CHCl), 1-chloro-2,3,3-trifluoropropene, (HCFO-1233yd-Z, CHF₂CF═CHCl), 2-(1,1,2,2-tetrafluoroethoxy)-1-fluoroethylene, (HFO-1345ezcEβγ, CFH═CHOCF₂CF₂H), 2,3,3,3-tetrafluoro-1-(1,1,2,2-tetrafluoroethoxy)prop-1-ene, (HFO-1438mzycEγδ, CF₃CF═CHOCF₂CF₂H), 1-(difluoromethoxy)-2,3,3,3-tetrafluoroprop-1-ene, (HFO-1336pzEαβ, CF₃CF═CHOCF₂H), 2,3,3-trifluoro-1-(trifluoromethoxy)prop-1-ene, (HFO-1336mzyEαβ, CHF₂CF═CHOCF₃), 1,1,1,2,2,5,5,6,6,6-decafluoro-3-hexene, (F22E, C₂F₅CH═CHC₂F₅), 1,1,1,2,2,3,3,4,4,7,7,8,8,9,9,10,10,10-octadecafluoro-5-decene, (F44E, C₄F₉CH═CHC₄F₉), or 1,1,1,2,3,4,4,5,5,5-decafluoropentane, (HFC-43-10mee, CF₃CHFCHFCF₂CF₃). In some embodiments, the co-compound includes at least one of HFO-1336mzz(E), HFO-1336mzz(Z), HFO-1234ze(Z), HFO-1234ye(E), HFO-1234ye(Z), or ethanol.

In an embodiment, the heat transfer process may involve providing an article and contacting the article with a heat transfer media. The heat transfer media includes a composition formed by a process including the steps of contacting a compound of formula (1),

R_{f}CH═CHF (1)
wherein R_{f} is a C₁-C₁₀ perfluorinated alkyl group, with a fluorinated ethylene compound of formula (2),

CX₁X₂═CX₃X₄ (2)
wherein X₁, X₂, X₃, and X₄ are each independently H, Cl, or F, and at least one of X₁, X₂, X₃, or X₄ is F. The process is conducted in the presence of a Lewis acid catalyst in an amount sufficient to form a composition including a compound of formula (3),

R_{f}CF₃(CX₅X₆CX₇X₈)ₙCH═CHCX₉X₁₀CX₁₁X₁₂F (3)
wherein X₅, X₆, X₇, and X₈ are each independently H, Cl, or F, n is an integer of 0 or 1, and the total number of each of H, Cl, and F represented by X₅, X₆, X₇, X₈, X₉, X₁₀, X₁₁, and X₁₂ is the same as the total number of each of H, Cl, and F provided by the fluorinated ethylene compound of formula (2). In some embodiments, the compound of formula (3) includes 1,1,1,2,2,5,5,6,6,7,7,7-dodecafluorohept-2-ene, C₃F₇CH═CHC₂F₅(F23E).

It would be appreciated by one of ordinary skill in the art that during the reaction of the compound of formula (1) and the compound of formula (2) that the bond formation may occur with either carbon of the compound of formula (2). In some embodiments, this may result in a mixture of isomers. In some embodiments, one isomer may predominate.

The heat transfer media composition may further optionally include one or more co-compounds. In one embodiment, the co-compound may be one of the co-compounds described above.

In an embodiment, the heat transfer process may include treating a surface by providing a surface and contacting the surface with a treatment composition. The treatment composition includes a composition formed by the process of, contacting a compound of formula (1),

R_{f}CH═CHF (1)
wherein R_{f} is a C₁-C₁₀ perfluorinated alkyl group, with a fluorinated ethylene compound of formula (2),

CX₁X₂═CX₃X₄ (2)
wherein X₁, X₂, X₃, and X₄ are each independently H, Cl, or F, and at least one of X₁, X₂, X₃, or X₄ is F. The process is conducted in the presence of a Lewis acid catalyst, in an amount sufficient, to form a composition including a compound of formula (3),

R_{f}CF₃(CX₅X₆CX₇X₈)ₙCH═CHCX₉X₁₀CX₁₁X₁₂F (3)
wherein X₅, X₆, X₇, and X₈ are each independently H, Cl, or F, n is an integer of 0 or 1, and the total number of each of H, Cl, and F represented by X₅, X₆, X₇, X₈, X₉, X₁₀, X₁₁, and X₁₂ is the same as the total number of each of H, Cl, and F provided by the fluorinated ethylene compound of formula (2). In some embodiments, the compound of formula (3) includes 1,1,1,2,2,5,5,6,6,7,7,7-dodecafluorohept-2-ene, C₃F₇CH═CHC₂F₅(F23E).

The surface treatment composition may further optionally include one or more co-compounds. In one embodiment, the co-compound may be the co-compound described above.

In an embodiment, the heat transfer system may include a refrigeration system. The refrigeration system includes any suitable components including an evaporator, a condenser, a compressor, an expansion device, and a heat transfer media. The heat transfer media includes a composition formed by the process of, contacting a compound of formula (1),

R_{f}CH═CHF (1)
wherein R_{f} is a C₁-C₁₀ perfluorinated alkyl group, with a fluorinated ethylene compound of formula (2),

CX₁X₂═CX₃X₄ (2)
wherein X₁, X₂, X₃, and X₄ are each independently H, Cl, or F, and at least one of X₁, X₂, X₃, or X₄ is F. The process is conducted in the presence of a Lewis acid catalyst in an amount sufficient to form a composition including a compound of formula (3),

R_{f}CF₃(CX₅X₆CX₇X₈)ₙCH═CHCX₉X₁₀CX₁₁X₁₂F (3)
wherein X₅, X₆, X₇ and X₈ are each independently H, Cl, or F, n is an integer of 0 or 1, and the total number of each of H, Cl, and F represented by X₅, X₆, X₇, X₈, X₉, X₁₀, X₁₁, and X₁₂ is the same as the total number of each of H, Cl, and F provided by the fluorinated ethylene compound of formula (2). In some embodiments, the compound of formula (3) includes 1,1,1,2,2,5,5,6,6,7,7,7-dodecafluorohept-2-ene, C₃F₇CH═CHC₂F₅(F23E).

In some embodiments, the condenser is operated at a temperature higher than 100° C., higher than 150° C., higher than 175° C., and/or higher than 200° C.

The heat transfer media may further optionally include one or more co-compounds. In one embodiment, the co-compound may be one of the co-compounds described above.

In an embodiment, a heat pipe system including a heat pipe having a working fluid therein. The working fluid includes a composition formed by the process of, contacting a compound of formula (1),

R_{f}CH═CHF (1)
wherein R_{f} is a C₁-C₁₀ perfluorinated alkyl group, with a fluorinated ethylene compound of formula (2),

CX₁X₂═CX₃X₄ (2)
wherein X₁, X₂, X₃, and X₄ are each independently H, Cl, or F, and at least one of X₁, X₂, X₃, or X₄ is F. The process is conducted in the presence of a Lewis acid catalyst, in an amount sufficient, to form a composition including a compound of formula (3),

R_{f}CF₃(CX₅X₆CX₇X₈)ₙCH═CHCX₉X₁₀CX₁₁X₁₂F (3)
wherein X₅, X₆, X₇, and X₈ are each independently H, Cl, or F, n is an integer of 0 or 1, and the total number of each of H, Cl, and F represented by X₅, X₆, X₇, X₈, X₉, X₁₀, X₁₁, and X₁₂ is the same as the total number of each of H, Cl, and F provided by the fluorinated ethylene compound of formula (2). In some embodiments, the compound of formula (3) includes 1,1,1,2,2,5,5,6,6,7,7,7-dodecafluorohept-2-ene, C₃F₇CH═CHC₂F₅(F23E).

The working fluid may further optionally include one or more co-compounds. In one embodiment, the co-compound may be one of the co-compounds described above.

In some embodiments, the compound of formula (3) undergoes a phase transition from the liquid to the gaseous state at a temperature of at least 25° C., at least 30° C., at least 40° C., at least 50° C., at least 60° C., less than 140° C., less than 130° C., less than 120° C., less than 110° C., less than 100° C., less than 90° C., less than 80° C., less than 70° C., and combinations thereof. In one embodiment, the compound of formula (3) undergoes a phase transition from the liquid to the gaseous state at a temperature between 50° C. and 90° C. In one embodiment, the compound of formula (3) undergoes a phase transition from the liquid to the gaseous state at a temperature between 75° C. and 80° C.

In some embodiments, the one or more co-compound, if present, also undergoes a phase transition from the liquid to the gaseous state at a temperature within the ranges described above. In some embodiments, the one or more co-compound undergoes a phase transition from the liquid to the gaseous state at a temperature within about 5° C. of the temperature of the phase transition from the liquid to the gaseous state of the compound of formula (3). In one embodiment, the co-compound undergoes a phase transition from the liquid to the gaseous state at a temperature within 3° C. of the temperature of the phase transition from the liquid to the gaseous state of the compound of formula (3).

In a further embodiment, the compositions disclosed herein may be used in combination with at least one lubricant selected from the group consisting of polyalkylene glycols, polyol esters, polyvinylethers, mineral oils, alkylbenzenes, synthetic paraffins, synthetic napthenes, and poly(alpha)olefins.

In one embodiment, lubricants may comprise those suitable for use with refrigeration or air-conditioning apparatus. Among these lubricants are those conventionally used in vapor compression refrigeration apparatus utilizing chlorofluorocarbon refrigerants. In one embodiment, lubricants comprise those commonly known as “mineral oils” in the field of compression refrigeration lubrication. Mineral oils comprise paraffins (i.e., straight-chain and branched-carbon-chain, saturated hydrocarbons), naphthenes (i.e. cyclic paraffins) and aromatics (i.e. unsaturated, cyclic hydrocarbons containing one or more rings characterized by alternating double bonds). In one embodiment, lubricants comprise those commonly known as “synthetic oils” in the field of compression refrigeration lubrication. Synthetic oils comprise alkylaryls (i.e. linear and branched alkyl alkylbenzenes), synthetic paraffins and naphthenes, and poly(alphaolefins). Representative conventional lubricants are the commercially available BVM 100 N (paraffinic mineral oil sold by BVA Oils), napthenic mineral oil commercially available from Crompton Co. under the trademarks Suniso® 3GS and Suniso® 5GS, naphthenic mineral oil commercially available from Pennzoil under the trademark Sontex® 372LT, napthenic mineral oil commercially available from Calumet Lubricants under the trademark Calumet® RO-30, linear alkylbenzenes commercially available from Shrieve Chemicals under the trademarks Zerol® 75, Zerol® 150 and Zerol® 500, and HAB 22 (branched alkylbenzene sold by Nippon Oil).

In another embodiment, lubricants may also comprise those, which have been designed for use with hydrofluorocarbon refrigerants and are miscible with refrigerants of the present invention under compression refrigeration and air-conditioning apparatus' operating conditions. Such lubricants include, but are not limited to, polyol esters (POEs) such as Castrol® 100 (Castrol, United Kingdom), polyalkylene glycols (PAGs) such as RL-488A from Dow (Dow Chemical, Midland, Mich.), polyvinyl ethers (PVEs), and polycarbonates (PCs).

Lubricants used with the compositions disclosed herein are selected by considering a given compressor's requirements and the environment to which the lubricant will be exposed.

In one embodiment, the compositions disclosed herein may further comprise an additive selected from the group consisting of compatibilizers, UV dyes, solubilizing agents, tracers, stabilizers, perfluoropolyethers (PFPE), and functionalized perfluoropolyethers.

In one embodiment, the compositions may be used with about 0.01 weight percent to about 5 weight percent of a stabilizer, free radical scavenger or antioxidant. Such other additives include but are not limited to, nitromethane, hindered phenols, hydroxylamines, thiols, phosphites, or lactones. Single additives or combinations may be used.

In an alternate embodiment, the compound of formula (1) may be dimerized. The compound of formula (1) may be reacted with itself, in the absence of the fluorinated ethylene compound of formula (2), in the presence of a catalyst, such as antimony fluoride (SbF₅). In some embodiments, the reaction may be performed in the presence of a solvent. Suitable solvents include those described above.

In an example of the alternate embodiment, a dimer may be formed by reacting 1,3,3,3-tetrafluoro-1-propene, CF₃CH═CHF (1234ze), as shown below.

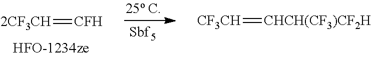

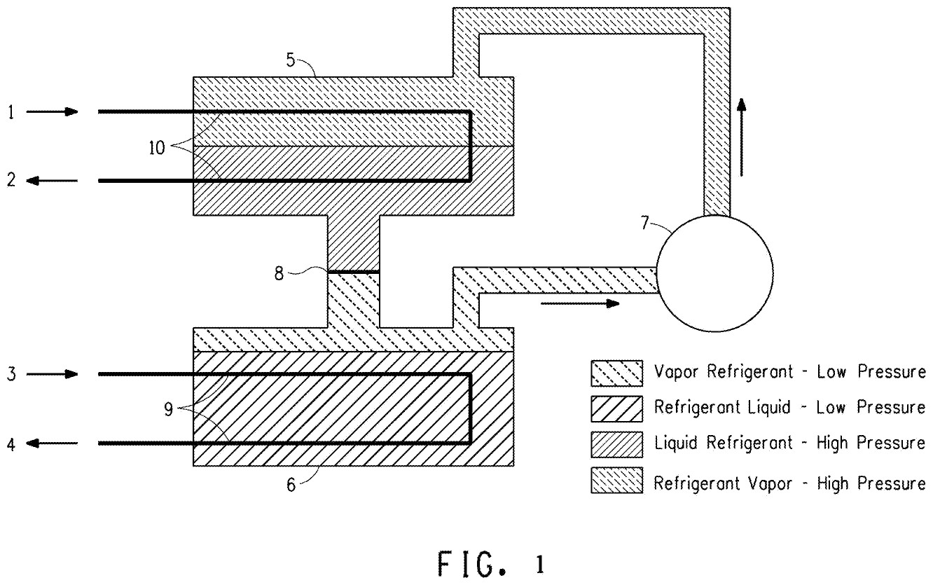

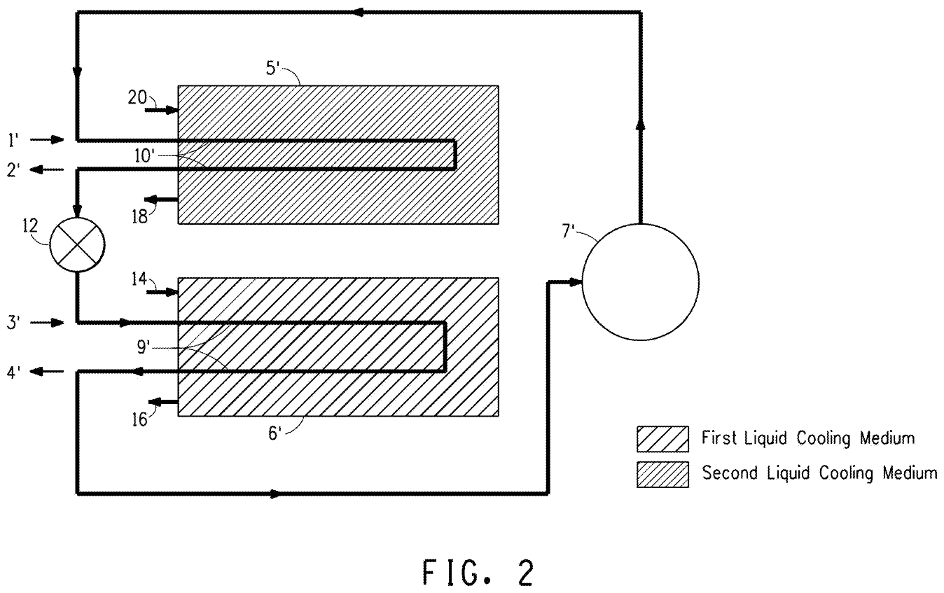

In one embodiment the compositions described above may be used in combination with a chiller apparatus, alternately referred to herein as a chiller. In an embodiment, the chiller may be a vapor compression chiller. Such vapor compression chillers may be either a flooded evaporator chiller, which is shown in FIG. 1, or a direct expansion chiller, which is shown in FIG. 2. Both a flooded evaporator chiller and a direct expansion chiller may be air-cooled or water-cooled. In the embodiment where chillers are water cooled, such chillers are generally associated with cooling towers for heat rejection from the system. In the embodiment where chillers are air-cooled, the chillers are equipped with refrigerant-to-air finned-tube condenser coils and fans to reject heat from the system. Air-cooled chiller systems are generally less costly than equivalent-capacity water-cooled chiller systems including cooling tower and water pump. However, water-cooled systems can be more efficient under many operating conditions due to lower condensing temperatures.

Chillers, including both flooded evaporator and direct expansion chillers, may be coupled with an air handling and distribution system to provide comfort air conditioning (cooling and dehumidifying the air) to large commercial buildings, including hotels, office buildings, hospitals, universities and the like. In another embodiment, chillers, most likely air-cooled direct expansion chillers, have found additional utility in naval submarines and surface vessels.

To illustrate how chillers operate using the inventive compositions, reference is made to the Figures. A water-cooled, flooded evaporator chiller is shown illustrated in FIG. 1. In this chiller a first cooling medium, which is a warm liquid, which comprises water, and, in some embodiments, additives, such as a glycol (e.g., ethylene glycol or propylene glycol), enters the chiller from a cooling system, such as a building cooling system, shown entering at arrow 3, through a coil 9, in an evaporator 6, which has an inlet and an outlet. The warm first cooling medium is delivered to the evaporator, where it is cooled by liquid refrigerant, which is shown in the lower portion of the evaporator. The liquid refrigerant evaporates at a lower temperature than the warm first cooling medium which flows through coil 9. The cooled first cooling medium re-circulates back to the building cooling system, as shown by arrow 4, via a return portion of coil 9. The liquid refrigerant, shown in the lower portion of evaporator 6 in FIG. 1, vaporizes and is drawn into a compressor 7, which increases the pressure and temperature of the refrigerant vapor. The compressor compresses this vapor so that it may be condensed in a condenser 5 at a higher pressure and temperature than the pressure and temperature of the refrigerant vapor when it comes out of the evaporator. A second cooling medium, which is a liquid in the case of a water-cooled chiller, enters the condenser via a coil 10 in condenser 5 from a cooling tower at arrow 1 in FIG. 1. The second cooling medium is warmed in the process and returned via a return loop of coil 10 and arrow 2 to a cooling tower or to the environment. This second cooling medium cools the vapor in the condenser and causes the vapor to condense to liquid refrigerant, so that there is liquid refrigerant in the lower portion of the condenser as shown in FIG. 1. The condensed liquid refrigerant in the condenser flows back to the evaporator through an expansion device 8, which may be an orifice, capillary tube or expansion valve. Expansion device 8 reduces the pressure of the liquid refrigerant, and converts the liquid refrigerant partially to vapor, that is to say that the liquid refrigerant flashes as pressure drops between the condenser and the evaporator. Flashing cools the refrigerant, i.e., both the liquid refrigerant and the refrigerant vapor to the saturated temperature at evaporator pressure, so that both liquid refrigerant and refrigerant vapor are present in the evaporator.

It should be noted that for a single component composition, such as a compound of formula (3), described above, the composition of the vapor refrigerant in the evaporator is the same as the composition of the liquid refrigerant in the evaporator. In this case, evaporation will occur at a constant temperature. However, if a refrigerant blend (or mixture). such as a compound of formula (3) in combination with a co-compound, is used, the liquid refrigerant and the refrigerant vapor in the evaporator (or in the condenser) may have different compositions.

Chillers with cooling capacities above 700 kW generally employ flooded evaporators, where the refrigerant in the evaporator and the condenser surrounds a coil or other conduit for the cooling medium (i.e., the refrigerant is on the shell side). Flooded evaporators require higher charges of refrigerant, but, permit closer approach temperatures and higher efficiencies. Chillers with capacities below 700 kW commonly employ evaporators with refrigerant flowing inside the tubes and cooling medium in the evaporator and the condenser surrounding the tubes, i.e., the cooling medium is on the shell side. Such chillers are called direct-expansion (DX) chillers. A water-cooled direct expansion chiller is illustrated in FIG. 2. In the chiller as illustrated in FIG. 2, first liquid cooling medium, which is a warm liquid, such as warm water, enters an evaporator 6′ at inlet 14. Mostly liquid refrigerant (with a small amount of refrigerant vapor) enters a coil 9′ in the evaporator at arrow 3′ and evaporates, turning to vapor. As a result, first liquid cooling medium is cooled in the evaporator, and a cooled first liquid cooling medium exits the evaporator at outlet 16, and is sent to a body to be cooled, such as a building. In this embodiment of FIG. 2, it is this cooled first liquid cooling medium that cools the building or other body to be cooled. The refrigerant vapor exits the evaporator at arrow 4′ and is sent to a compressor 7′, where it is compressed and exits as high temperature, high pressure refrigerant vapor. This refrigerant vapor enters a condenser 5′ through a condenser coil 10′ at 1′. The refrigerant vapor is cooled by a second liquid cooling medium, such as water, in the condenser and becomes a liquid. The second liquid cooling medium enters the condenser through a condenser cooling medium inlet 20. The second liquid cooling medium extracts heat from the condensing refrigerant vapor, which becomes liquid refrigerant, and this warms the second liquid cooling medium in the condenser. The second liquid cooling medium exits through the condenser through the condenser cooling medium outlet 18. The condensed refrigerant liquid exits the condenser through lower coil 10′ as shown in FIG. 2 and flows through an expansion device 12, which may be an orifice, capillary tube or expansion valve. Expansion device 12 reduces the pressure of the liquid refrigerant. A small amount of vapor, produced as a result of the expansion, enters the evaporator with liquid refrigerant through coil 9′ and the cycle repeats.

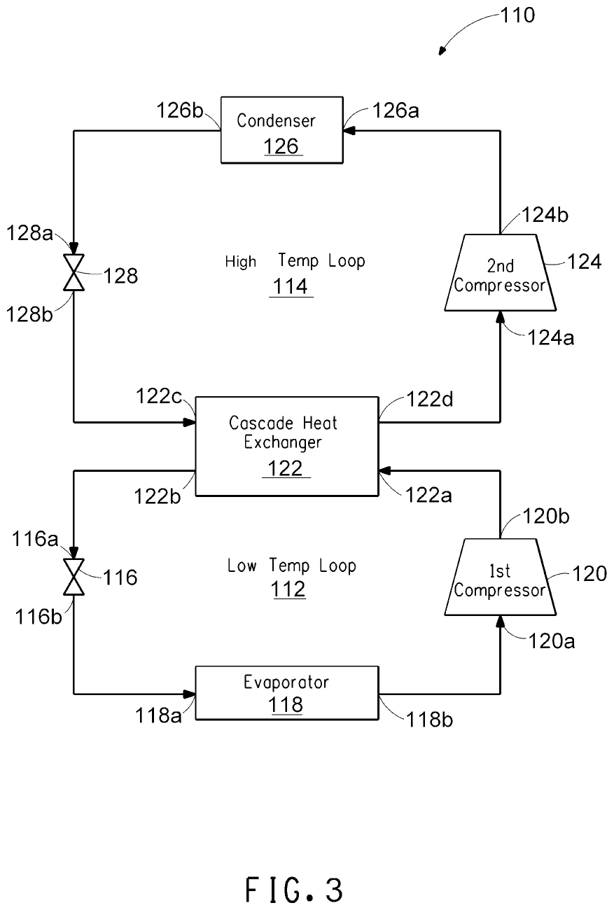

In another embodiment, the chiller apparatus may be a high temperature heat pump apparatus having at least two heating stages arranged as a cascade heating system, each stage circulating a working fluid therethrough comprising (a) a first expansion device for reducing the pressure and temperature of a first working fluid liquid; (b) an evaporator in fluid communication with the first expansion device having an inlet and an outlet; (c) a first compressor in fluid communication with the evaporator and having an inlet and an outlet; (d) a cascade heat exchanger system in fluid communication with the first compressor and having: (i) a first inlet and a first outlet, and (ii) a second inlet and a second outlet in thermal communication with the first inlet and outlet; (e) a second compressor in fluid communication with the second outlet of the cascade heat exchanger and having an inlet and an outlet; (f) a condenser in fluid communication with the second compressor and having an inlet and an outlet; and (g) a second expansion device in fluid communication with the condenser; wherein the second working fluids comprises at least one alkyl perfluoroalkene ether. In accordance with the present invention, there is provided a cascade heat pump system having at least two heating loops for circulating a working fluid through each loop. One embodiment of such a cascade system is shown generally at 110 in FIG. 3. Cascade heat pump system 110 of the present invention has at least two heating loops, including a first, or lower loop 112, which is a low temperature loop, and a second, or upper loop 114, which is a high temperature loop 114 as shown in FIG. 3. Each circulates a working fluid therethrough.

Cascade heat pump system 110 includes first expansion device 116. First expansion device 116 has an inlet 116a and an outlet 116b. First expansion device 116 reduces the pressure and temperature of a first working fluid liquid which circulates through the first or low temperature loop 112.

Cascade heat pump system 110 also includes evaporator 118. Evaporator 118 has an inlet 118a and an outlet 118b. The first working fluid liquid from first expansion device 116 enters evaporator 118 through evaporator inlet 118a and is evaporated in evaporator 118 to form a first working fluid vapor. The first working fluid vapor then circulates to evaporator outlet 118b.

Cascade heat pump system 110 also includes first compressor 120. First compressor 120 has an inlet 120a and an outlet 120b. The first working fluid vapor from evaporator 118 circulates to inlet 120a of first compressor 120 and is compressed, thereby increasing the pressure and the temperature of the first working fluid vapor. The compressed first working fluid vapor then circulates to the outlet 120b of the first compressor 120.

Cascade heat pump system 110 also includes cascade heat exchanger system 122. Cascade heat exchanger 122 has a first inlet 122a and a first outlet 122b. The first working fluid vapor from first compressor 120 enters first inlet 122a of heat exchanger 122 and is condensed in heat exchanger 122 to form a first working fluid liquid, thereby rejecting heat. The first working fluid liquid then circulates to first outlet 122b of heat exchanger 122. Heat exchanger 122 also includes a second inlet 122c and a second outlet 122d. A second working fluid liquid circulates from second inlet 122c to second outlet 122d of heat exchanger 122 and is evaporated to form a second working fluid vapor, thereby absorbing the heat rejected by the first working fluid (as it is condensed). The second working fluid vapor then circulates to second outlet 122d of heat exchanger 122. Thus, in the embodiment of FIG. 3, the heat rejected by the first working fluid is directly absorbed by the second working fluid.

Cascade heat pump system 110 also includes second compressor 124. Second compressor 124 has an inlet 124a and an outlet 124b. The second working fluid vapor from cascade heat exchanger 122 is drawn into compressor 124 through inlet 124a and is compressed, thereby increasing the pressure and temperature of the second working fluid vapor. The second working fluid vapor then circulates to outlet 124b of second compressor 124.

Cascade heat pump system 110 also includes condenser 126 having an inlet 126a and an outlet 126b. The second working fluid from second compressor 124 circulates from inlet 126a and is condensed in condenser 126 to form a second working fluid liquid, thus producing heat. The second working fluid liquid exits condenser 126 through outlet 126b.

Cascade heat pump system 110 also includes second expansion device 128 having an inlet 128a and an outlet 128b. The second working fluid liquid passes through second expansion device 128, which reduces the pressure and temperature of the second working fluid liquid exiting condenser 126. This liquid may be partially vaporized during this expansion. The reduced pressure and temperature second working fluid liquid circulates to second inlet 122c of cascade heat exchanger system 122 from expansion device 128.

As used herein, the terms “comprises,” “comprising,” “includes,” “including,” “has,” “having” or any other variation thereof, are intended to cover a non-exclusive inclusion. For example, a composition, process, method, article, or apparatus that comprises a list of elements is not necessarily limited to only those elements but may include other elements not expressly listed or inherent to such composition, process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The transitional phrase “consisting of” excludes any element, step, or ingredient not specified. If in the claim such would close the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” is used to define a composition, method that includes materials, steps, features, components, or elements, in addition to those literally disclosed provided that these additional included materials, steps, features, components, or elements do materially affect the basic and novel characteristic(s) of the claimed invention, especially the mode of action to achieve the desired result of any of the processes of the present invention. The term ‘consisting essentially of’ occupies a middle ground between “comprising” and ‘consisting of’.

Where applicants have defined an invention or a portion thereof with an open-ended term such as “comprising,” it should be readily understood that (unless otherwise stated) the description should be interpreted to also include such an invention using the terms “consisting essentially of” or “consisting of.”

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

The following Examples are provided to illustrate certain embodiments of the invention and shall not limit the scope of any claims appended hereto.

### EXAMPLES

Exemplary examples of the formation of compounds of formula (3) are shown below:

### Example 1

Reaction of HFO-1234ze with Chlorotrifluoroethylene Catalyzed by SbF5

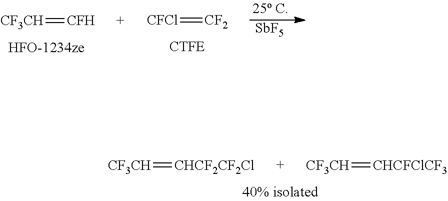

A 400 ml Hastelloy® shaker tube was loaded with 12 g (0.055 mol) of SbF₅, shaker tube was cooled down in dry ice, evacuated and charged with 150 g (1.32 mol) of HFO-1234ze and 150 g (1.29 mol) of chlorotrifluoroethylene (CTFE). It was placed in barricade and was warmed up to ambient temperature and kept agitated for 16 hours. The reaction vessel was cooled down with ice, vented off and liquid product was added to 1 L of water. Organic layer was separated, dried over MgSO₄ and filtered to give 290 g of crude material. It was fractionated to give 148 g (50% yield) of fraction b.p. 59-62° C., which was identified as a mixture of CF₃CH═CHCF₂CF₂Cl and CF₃CH═CHCFClCF₃ in ratio 36:64 (purity of this fraction was 97.8%). This fraction was redistilled to give 120 g of material 99.3% purity, b.p. 60-61° C.
E-CF₃CH═CHCF₂CF₂Cl:
¹⁹F NMR (CDCl₃): −66.38 (3F, m), −71.74 (2F, m), −113.98 (2F, m) ppm E-CF₃CH═CHCFClCF₃:
¹⁹F NMR (CDCl₃): −66.90 (3F, m), −82.15 (3F, m), −131.82 (1F, m) ppm
¹H NMR (CDCl₃, mixture isomers): 6.48 (m) ppm GC/MS (m/z, mixture of isomers): 230 (M⁺, C₅H₂ClF₇⁺)

The ratio of CF₃CH═CHCF₂CF₂Cl and CF₃CH═CHCFClCF₃ in the reaction product mixture can vary. The reaction product ratio can range from about 30:70, about 32:68, about 34:66 and in some cases about 36:64.

### Example 2

Reaction of HFO-1234ze with Chlorotrifluoroethylene Catalyzed by AlCl₃

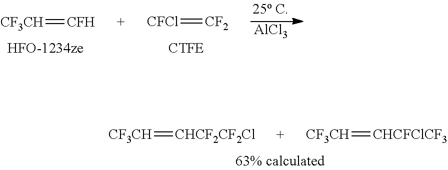

A 400 ml Hastelloy® shaker tube was loaded with 12 g (0.09 mol) of anhydrous pulverized AlCl₃, shaker tube was cooled down in dry ice, evacuated and charged with 75 g (0.66 mol) of HFO-1234ze and 75 g (0.64 mol) of chlorotrifluoroethylene (CTFE). Shaker tube was placed in barricade, warmed up to ambient temperature and kept agitated for 16 hours. The reactor was cooled down with ice, vented off and liquid product was added to 1 L of water. Organic layer was separated, dried over MgSO₄ and filtered to give 148 g of crude material, which was found to contain 68% of a mixture of CF₃CH═CHCF₂CF₂Cl and CF₃CH═CHCFClCF₃ (ratio of CF₃CH═CHCF₂CF₂Cl and CF₃CH═CHCFClCF₃ 54:46) along with higher coiling point materials. Calculated yield of C₅H₂ClF₇ fraction was 66%.

If desired, the amount of catalyst can be varied. The reaction product ratio of CF₃CH═CHCF₂CF₂Cl and CF₃CH═CHCFClCF₃ can range from about 64:36, about 62:38, and in some cases about 60:40.

### Reaction of HFO-1234ze with SbF₅ (Comparative Example)

A 1 L Hastelloy® shaker tube agitated reactor was charged with 11 g (0.05 mol) of SbF₅, cooled down with dry ice, leak checked by pressurizing with nitrogen, vented, evacuated and 500 g (4.4 mol) of HFO-1234ze was condensed into the reactor. It was brought to ambient temperature and kept at 25-30° C. for 12 hours. Water (100 ml) was injected into the reactor using a pump. The reactor was vented, opened and the reaction mixture was added to separatory funnel containing 1 L of water, organic layer was separated, dried oven MgSO₄, filtered to give 474 g of crude product, which was further flash distilled to yield 400 g of crude product. Fractionation using 36 inch glass column with Hastelloy® packing and gave 350 g (70% yield) of material with b.p. 86-87° C., identified by NMR and GC/MS as E-CF₃CH═CHCH(CF₃)CF₂H, containing 3% of Z-isomer.
E-CF3CH═CHCH(CF₃)CF₂H:
¹⁹F NMR (CDCl₃): −65.86 (3F, m), −67.47 (3F, m), −120.00 (1F, ddm, 300, 54.1 Hz), −123.60 (1F, ddm, 300, 54.1 Hz) ppm
¹H (NMR(CDCl₃, mixture isomers)): 6.06 (1H, m), 6.10 (1H, t, d, 54.1, 2.5 Hz), 6.33 (1H, m) ppm
GC/MS (m/z): 228 (M⁺, C₆H₄F₈⁺)

### Example 3

Reaction of HFO-153-10ze with chlorotrifluoroethylene catalyzed by AlCl₃

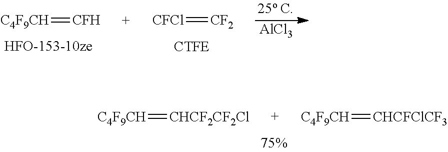

A 50 ml flask was loaded with 1.0 g (0.007 mol) of anhydrous pulverized AlCl₃ inside of dry box. It was equipped with thermocouple, magnetic stir bar and dry ice condenser connected to nitrogen line. The reactor was cooled down with ice, charged with 11 g (0.042 mol) of HFO-153-10ze (C₄F₉CH═CHF) and 5 g (0.042 mol) of chlorotrifluoroethylene (CTFE) was introduced into reaction mixture through gas inlet tube over period of 30 minutes. The reaction vessel was slowly warmed up to ambient temperature in water bath and was kept agitated for 4 hours. Crude reaction mixture was diluted with 300 ml of water, organic layer was separated, dried over MgSO₄ and filtered to give 15 g of crude material, which was distilled using 10 inch Vigreux column to give 7.9 g (75%) of material boiling at 120-129° C. and containing a mixture of C₄F₉CH═CHCF₂CF₂Cl and C₄F₉CH═CHCFClCF₃ (ratio 54:56), along with 3% of higher boiling point material.

E-C₄F₉CH═CHCF₂CF₂Cl:
¹⁹F NMR (CDCl3, J, Hz): −71.53 (2F, t, 4.7, Hz), −81.10 (3Ft, 8.5, Hz), −113.68 (2F, m), −114.16 (2F, m) −124.35 (2F, m), −125.85 (2F, m) ppm
¹H NMR (CDCl3 J, Hz): 6.50 (m)
E-C₄F₉CH═CHCFClCF₃:
¹⁹F NMR (CDCl3, J, Hz): −81.10 (3Ft, 8.5, Hz), −81.84 (3F, d, 7.1, Hz), −113.68 (2F, m), −124.35 (2F, m), −125.85 (2F, m), −131.68 (1F, m) ppm
¹H NMR (CDCl3 J, Hz): 6.50 (m)
MS (z/e, mixture of isomers): 361 [(M−F)⁺, C₈H₂ClF₁₂⁺)
The reaction product ratio of C₄F₉CH═CHCF₂CF₂Cl and C₄F₉CH═CHCFClCF₃ can range from about 64:36, about 62:38, and in some cases about 60:40.

### Example 4

Reaction of HFO-1234ze with Tetrafluoroethylene Catalyzed by AlCl3

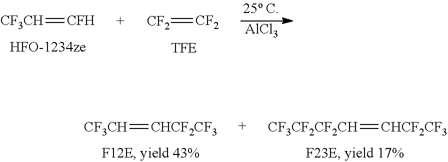

A 400 ml Hastelloy® shaker tube was loaded with 5 g (0.038 mol) of anhydrous pulverized AlCl₃, shaker tube was cooled down in dry ice, evacuated and charged with 60 g (0.52 mol) of HFO-1234ze and 50 g (0.5 mol) of tetrafluoroethylene (TFE). Shaker tube was placed in barricade and was warmed up to ambient temperature for 2 hours. It was charged with another 50 g (0.5 mol) of TFE and kept agitated for 12 hours. The reactor was cooled down with ice, vented off and liquid product (140 g) was added to 1 L of water. Organic layer was separated, dried over MgSO₄ and filtered to give 130 g of crude material, containing 65% of E-CF₃CH═CHCF₂CF₃ (F12E) and 35% E-C₂F₅CH═CHC₃F₇(F23E). Fractionation using 10 inch Vigreux column gave 46 g (yield 43%) of identified by GC/MS and NMR as CF₃CH═CHCF₂CF₃ (b.p. 29-30° C.) and 28 g (yield 17%) of material b.p.70-74° C. (main 73-74° C.) identified by NMR and GC/MS as E-C₂F₅CH═CHC₃F₇ (purity 98%).

E-CF3CH═CHCF₂CF₃:
¹⁹F NMR (CDCl₃): −66.30 (3F, dm, 4.1, 1.5 Hz), −85.07 (3F, m), −117.98 (2F, dm, 8.7, 2.3 Hz) ppm
GC/MS (m/z): 214 (M⁺, C₅H₂F₈⁺)
¹H NMR (CDCl₃): 6.46 (m) ppm
E-C₂F₅CH═CHC₃F₇:
¹⁹F NMR (CDCl₃): −80.66 (3F, t, 9.1 Hz), −85.07 (3F, m), −115.28 (2F, quint., 8.7 Hz), −117.88 (2F, dm, 8.5, 2.0 Hz), −127.88 (2F, s) ppm
¹H NMR (CDCl₃): 6.46 (m) ppm
GC/MS (m/z): 314 (M⁺, C₇H₂F₁₂⁺)

If desired, the E-CF₃CH═CHCF₂CF₃ (F12E) and E-C₂F₅CH═CHC₃F₇(F23E) in the reaction product mixture can be varied by varying the amount of reactants. The amount of E-CF₃CH═CHCF₂CF₃ (F12E) and E-C₂F₅CH═CHC₃F₇(F23E) in the reaction product can vary from 1 to 100 wt %, about 25 to 75 wt. % and in some cases about 50 to 50 wt. %.

### Example 5

Reaction of HFO-1234ze with Vinylidene Fluoride Catalyzed by AlCl₃

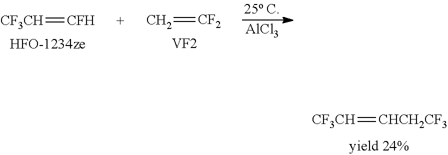

This reaction was carried out in similar fashion in 400 ml Hastelloy® shaker tube, using with 5 g (0.038 mol) of anhydrous pulverized AlCl₃, 60 g (0.52 mol) of HFO-1234ze and 32 g (0.5 mol) of vinylidene fluoride (VF2) added to cold reaction vessel in one portion. The reaction mixture was worked up as it was described above. Crude product (89 g) was distilled to give 21 g (yield 24%) of fraction with boiling point 63-68° C., identified as a mixture of E-CF₃CH═CHCH₂CF₃ and Z-CF₃CH═CHCH₂CF₃ (ratio 92:8) by GC/MS and NMR, along with 60 g of higher boiling point material, which was not characterized.

E-CF₃CH═CHCH₂CF₃:
¹⁹F NMR (CDCl₃): −65.93 (3F, t, 9.2 Hz), −65.31 (3F, dm, 5.2, 1.5 Hz) ppm
¹H NMR (CDCl₃): 2.97 (2H, quint, 8.6 Hz), 5.91 (1H, m), 6.33 (1H, m) ppm
Z-CF₃CH═CHCH₂CF₃:
¹⁹F NMR (CDCl₃): −59.36 (3F, d, 7.9 Hz), −66.41 (3F, t, 9.2 Hz) ppm
¹H NMR (CDCl₃): 3.16 (2H, quint, 8.6 Hz), 5.91 (m), 6.33 (1H, m) ppm GC/MS (m/z, mixture isomers): 178 (M⁺, C₅H₄F₆⁺)

The ratio of E-CF₃CH═CHCH₂CF₃ and Z-CF₃CH═CHCH₂CF₃ in the product mixture can range from about 1 to 100 wt %, about 25 to 75 wt. % and in some cases about 50 to 50 wt %. The ratio can be varied by changing at least one of the ratio of reactants, an optional solvent and temperature.

### Reaction of HFO-1234yf with Tetrafluoroethylene Catalyzed by AlCl₃ (Comparative Example)

A reaction of 5 g (0.038 mol) of anhydrous, pulverized AlCl₃, 115 g (1 mol) of HFO-1234yf (CF₃CF═CH₂, isomer of HFO-1234ze) and 50 g of TFE was carried out as described above in 400 ml Hastelloy® shaker tube at ambient temperature. No pressure drop was observed over a 16-hour period and no liquid product was recovered after shaker tube was vent off.

### Example 6

### Cycle Model for an Organic Rankine Cycle

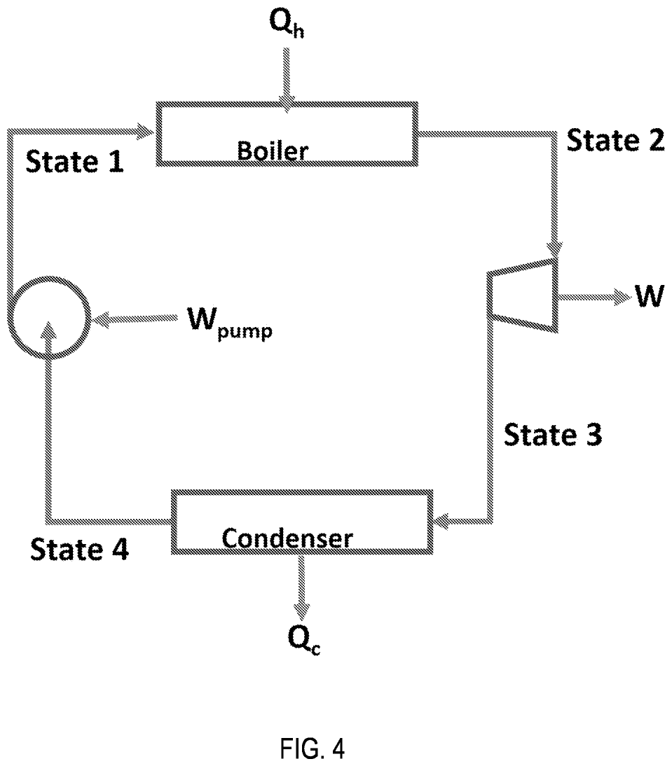

FIG. 4 is a schematic drawing of an Organic Rankine Cycle (ORC) model. The ORC efficiency for certain inventive compositions was determined by using mass and energy balances that specify the system and unit operations shown in FIG. 4. Typical conditions for ORC systems to generate power from low temperature heat sources were used to calculate theoretical performance. Accordingly, the average condenser and boiler temperatures are 40° C. and 100° C. respectively, and 5 K for both superheating and subcooling. The isentropic efficiencies for the pump compression and turbine expansion are 85 and 50% respectively. The efficiency of the power generation is the percentage of the heat input energy that is leveraged as net shaft work, that is 100%×(W−Wₚᵤₘₚ)/Qₕ. The volumetric power generation capacity is the next shaft work multiplied by the density of the fluid exiting the turbine, i.e. (W−Wₚᵤₘₚ)×ρ₃. W is the work output from the turbine, Wₚᵤₘₚ is the work input to the pump, Qₕ is the heat source input and ρ₃ is the density of the fluid exiting the turbine.

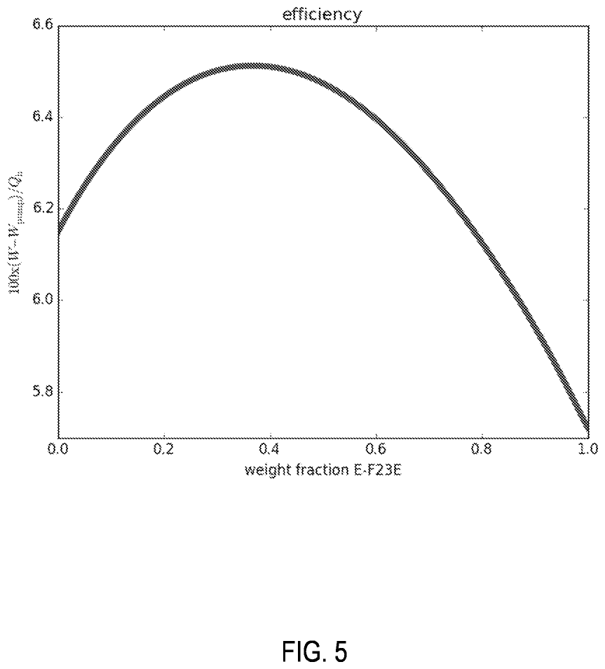

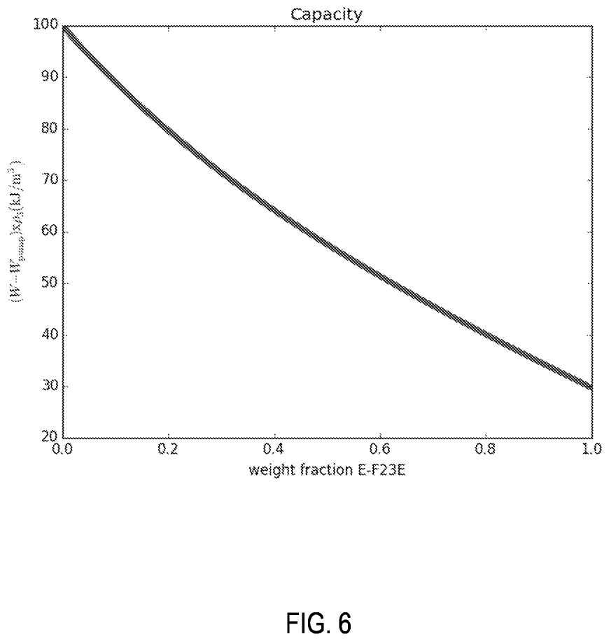

The efficiency and capacity of binary fluid blends over the entire composition range were determined. FIGS. 5 and 6 demonstrates the dependence of efficiency and capacity on fluid composition for product component, formula (3), E-F23E with the co-compound R-1336mzzZ. It can be seen from FIG. 5 that the theoretical efficiency has a maximum at 37 wt-% E-F23E. This maximum efficiency at 37 wt-% E-F23E was compared to R-1233zdE, R-1225yeE, R-1225yeZ, and R245fa. As shown in Table 1, E-F23E/R-1336mzzZ—ranging from about 30 to about 40 F23E and 70 to 60 wt. % R-1336mzzZ is efficient and, in particular, a 37/63 wt-% blend results in the largest efficiency.

TABLE 1
Comparison of ORC metrics of E-F23E/R-1336mzzZ
(37/63 wt-%) with other working fluids.

| | T_turbine_in | T_turbine_out | P_condenser | P_boiler | CAP | |
|---|---|---|---|---|---|---|
| fluid | (° C.) | (° C.) | (MPa) | (MPa) | (kJ/m\hat{ }3) | efficiency |
| E-F23E/R- | 110 | 87.2 | 0.074 | 0.509 | 66.2 | 6.51 |
| 1336mzzZ - | | | | | | |
| 37/63 wt-% | | | | | | |
| R-1233zdE | 105 | 71.8 | 0.216 | 1.04 | 152 | 6.34 |
| R-245fa | 105 | 72.5 | 0.251 | 1.26 | 179 | 6.17 |
| R-1225yeE | 105 | 60.2 | 0.695 | 2.74 | 343 | 5.33 |
| R-1225yeZ | 105 | 55.3 | 0.781 | 3.10 | 363 | 5.07 |

### Example 7

### HTHP Cycle Model

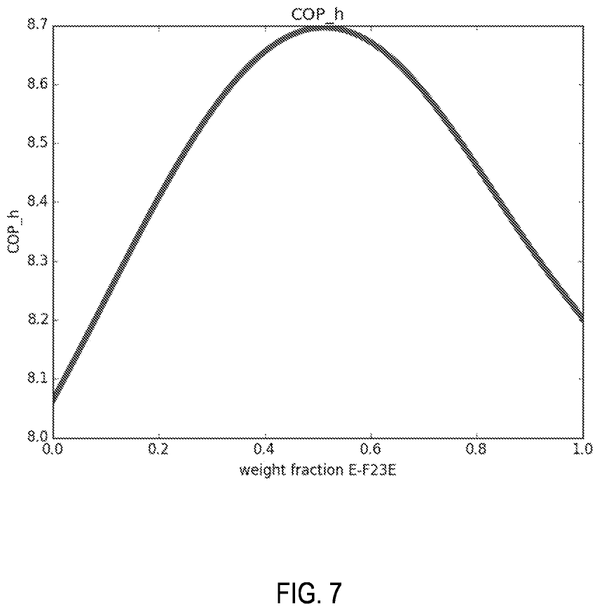

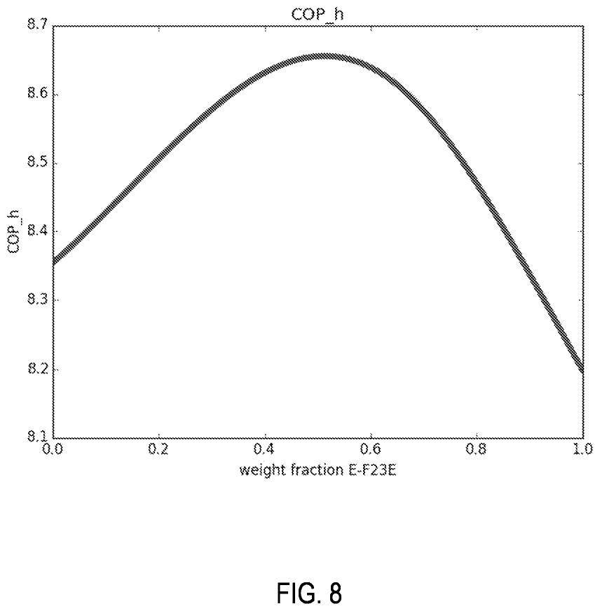

The heating coefficient of performance (COPₕ) and volumetric heating capacity (CAPₕ) for certain inventive compositions were determined by using mass and energy balances that specify the system and unit operations shown in FIG. 2. The average evaporator and condenser temperatures are 70° C. and 100° C. respectively, for a 30-degree temperature lift. There are 5 and 10 Kelvins of superheating and subcooling respectively. The isentropic efficiency for the compression is 70%. COPₕ is the ratio of the high temperature heat output per kg of working fluid circulating through the condenser, the heating effect (Qₕ), to the power input to the compressor per kg of working fluid circulating through the compressor (W), that is Qₕ/W. CAPₕ is the product of the heating effect and the density of the fluid entering the compressor (ρ₁), that is Qₕ×ρ₁. These conditions were used to calculate the COPₕ and CAPₕ of certain inventive binary fluid blends over a range of compositions. FIGS. 7 and 8 illustrate the dependence of COPₕ on fluid composition for two binary working fluids: 1) E-F23E with E-F12E; and 2) E-F23E with co-compound R-1336mzzZ, respectively. It can be seen from FIGS. 7 and 8 that COPₕ has maxima for both binary systems at about 51 wt-% E-F23E.

The binary compositions exhibited maximum COPₕ values at 51 wt-% E-F23E. This maximum efficiency for both inventive blends at about 51 wt-% E-F23E were compared to neat fluids E-F23E, E-F12E, R-1336mzzZ, R-1233zdE, and R245fa. As shown in Table 2, both inventive blends, E-F23E/E-F12E and E-F23E/R-1336mzzZ, both at about 51 wt-% E-F23E, have the largest COPₕ values, with E-F23E/E-F12E at 51 wt-% E-F23E having the largest COPₕ value.

TABLE 2
Comparison of E-F23E with E-F12E and R-1336mzzZ (both
at 51 wt-% E-F23E) with other working fluids

| | T_discharge | P_suction | (P_discharge | CAP_h | | Q_h | rho_1 |
|---|---|---|---|---|---|---|---|
| fluid | (° C.) | (MPa) | MPa) | (kJ/m\hat{ }3) | COP_h | (kJ/kg) | (kg/m\hat{ }3) |
| E-F23E/E-F12E \| | 99.1 | 0.199 | 0.458 | 2010 | 8.69 | 107 | 18.7 |
| 51/49 wt-% | | | | | | | |
| E-F23E/ | 101 | 0.194 | 0.440 | 1930 | 8.66 | 124 | 15.6 |
| R-1336mzzZ \| | | | | | | | |
| 51/49 wt-% | | | | | | | |
| E-F23E | 90.5 | 0.093 | 0.220 | 923 | 8.20 | 86.3 | 10.7 |
| E-F12E | 95.3 | 0.381 | 0.822 | 3240 | 8.06 | 101 | 31.9 |
| R-1336mzzZ | 99.9 | 0.327 | 0.706 | 2930 | 8.35 | 141 | 20.8 |
| R-245fa | 104 | 0.609 | 1.265 | 51120 | 8.25 | 156 | 32.7 |
| R-1233zdE | 106 | 0.511 | 1.042 | 4280 | 8.36 | 162 | 26.4 |

While the invention has been described with reference to one or more embodiments, it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

1. A process for transferring heat, comprising:
providing an article;
contacting the article with a heat transfer media;
wherein the heat transfer media comprises a composition comprising a compound of formula (4),
R_{f}CF₃(CX₅X₆CX₇X₈)ₙCH═CHCX₉X₁₀CX₁₁X₁₂F (4)
wherein R_{f} is a C₁-C₁₀ perfluorinated alkyl group;
wherein X₅, X₆, X₇, X₈, X₉, X₁₀, X₁₁, and X₁₂ are each independently H, Cl, or F, n is an integer of 0 or 1; and
wherein the total number of F represented by X₅, X₆, X₇, X₈, X₉, X₁₀, X₁₁, and X₁₂ is at least two; and, optionally,
a co-compound including at least one of (E)-1,1,1,4,4,4-hexafluoro-2-butene, (Z)-1,1,1,4,4,4-hexafluoro-2-butene, (E)-2,3-bis(trifluoromethyl)oxirane, (Z)-2,3-bis(trifluoromethyl)oxirane, HFO-1234ze(Z), HFO-1234ye(E), HFO-1234ye(Z), HFO-1438mzz(E), HFO-1438mzz(Z), Heptafluoro-4-(trifluoromethyl)-pent-2-ene, HFO-162-13mcyz, HFO-162-13mczy, (E)-1,3,4,4,4-pentafluoro-3-(trifluoromethyl)-1-butene, (Z)-1,3,4,4,4-pentafluoro-3-(trifluoromethyl)-1-butene, HFO-1336ze(E), HFO-1336ze(Z), HFC-245fa, HFC-245ea, HFC-365mfc, (E)-1-chloro-3,3,3-trifluoro-propene, (Z)-1-chloro-3,3,3-trifluoro-propene, HCFO-1224yd(E), HCFO-1224yd(Z), iso-pentane, n-pentane, cyclo-pentane, n-hexane, cyclohexane, heptane, methyl formate, dimethoxymethane, dimethoxyethane, propanal, methanol, ethanol, isopropanol, n-propanol, trans-1,2-dichloro-ethylene, cis-1,2 dichloro-ethylene, 1-methoxyheptafluoropropane, methyl nonafluorobutyl ether, methoxy-nonafluorobutane, ethoxy-nonafluorobutane, dodecafluoro-2-methylpentan-3-one, 1,1,1,2,2,3,4,5,5,5-decafluoro-3-methoxy-4-(trifluoromethyl)-pentane, siloxanes, methyl perfluoroheptene ether, MPPE, perfluorohept-2-ene/perfluorohept-3-ene PFH mixture, Perfluorohept-1-ene, 1-bromo-1,2,3,3,3-pentafluoropropene, 2-bromo-1,1,1,3,3-pentafluoro-2-propene, (E)-1-Bromo-2,3,3,3-tetrafluoropropene, (Z)-1-Bromo-2,3,3,3-tetrafluoropropene, 2-bromo-3,3,3-trifluoro-propene, trans-DCE/R-1336mzz(Z) mixtures, trans-DCE/methylperfluoroheptene ethers, trans-DCE/HFC-43-10mee mixtures, 2-bromo-2-chloro-1,1,1-trifluoroethane, 2,3-dichloro-3,3-difluoropropene, (E)-1,1,4,4-tetrafluoro-2-butene, 2-bromo-1,1-difluoroethane, 1-chloro-2,3,3,4,4,4-hexafluoro-1-butene, 1-chloro-2,3,3-trifluoropropene, 2-(1,1,2,2-tetrafluoroethoxy)-1-fluoroethylene, 2,3,3,3-tetrafluoro-1-(1,1,2,2-tetrafluoroethoxy)prop-1-ene, 1-(difluoromethoxy)-2,3,3,3-tetrafluoroprop-1-ene, 2,3,3-trifluoro-1-(trifluoromethoxy)prop-1-ene, 1,1,1,2,2,5,5,6,6,6-decafluoro-3-hexene, 1,1,1,2,2,3,3,4,4,7,7,8,8,9,9,10,10,10-octadecafluoro-5-decene, or 1,1,1,2,3,4,4,5,5,5-decafluoropentane.

2. The process of claim 1, wherein the compound of formula (4) includes 1,1,1,2,2,5,5,6,6,7,7,7-dodecafluorohept-2-ene.

3. The process of claim 2, wherein the co-compound includes:
at least one of HFO-1336mzz(E), HFO-1336mzz(Z), HFO-1234ze(Z), HFO-1234ye(E), HFO-1234ye(Z), or ethanol.

4. A process for transferring heat, comprising:
providing an article;
contacting the article with a heat transfer media;
wherein the heat transfer media comprises a composition formed by the process of,
contacting a compound of formula (1),
R_{f}CH═CHF (1)
wherein R_{f} is a C₁-C₁₀ perfluorinated alkyl group;
with a fluorinated ethylene compound of formula (2),
CX₁X₂═CX₃X₄ (2)
wherein X₁, X₂, X₃, and X₄ are each independently H, Cl, or F; and
wherein at least one of X₁, X₂, X₃, or X₄ is F;
in the presence of a Lewis acid catalyst in an amount sufficient to form a composition comprising a compound of formula (3),
R_{f}CF₃(CX₅X₆CX₇X₈)ₙCH═CHCX₉X₁₀CX₁₁X₁₂F (3)
wherein X₅, X₆, X₇, X₈, X₉, X₁₀, X₁₁, and X₁₂ are each independently H, Cl, or F, n is an integer of 0 or 1; and
wherein the total number of each of H, Cl, and F represented by X₅, X₆, X₇, X₈, X₉, X₁₀, X₁₁, and X₁₂ is the same as the total number of each of H, Cl, and F provided by the fluorinated ethylene compound of formula (2); and, optionally,
a co-compound including at least one of
(E)-1,1,1,4,4,4-hexafluoro-2-butene, (Z)-1,1,1,4,4,4-hexafluoro-2-butene, (E)-2,3-bis(trifluoromethyl)oxirane, (Z)-2,3-bis(trifluoromethyl)oxirane, HFO-1234ze(Z), HFO-1234ye(E), HFO-1234ye(Z), HFO-1438mzz(E), HFO-1438mzz(Z), Heptafluoro-4-(trifluoromethyl)-pent-2-ene, HFO-162-13mcyz, HFO-162-13mczy, (E)-1,3,4,4,4-pentafluoro-3-(trifluoromethyl)-1-butene, (Z)-1,3,4,4,4-pentafluoro-3-(trifluoromethyl)-1-butene, HFO-1336ze(E), HFO-1336ze(Z), HFC-245fa, HFC-245ea, HFC-365mfc, (E)-1-chloro-3,3,3-trifluoro-propene, (Z)-1-chloro-3,3,3-trifluoro-propene, HCFO-1224yd(E), HCFO-1224yd(Z), iso-pentane, n-pentane, cyclo-pentane, n-hexane, cyclohexane, heptane, methyl formate, dimethoxymethane, dimethoxyethane, propanal, methanol, ethanol, isopropanol, n-propanol, trans-1,2-dichloro-ethylene, cis-1,2 dichloro-ethylene, 1-methoxyheptafluoropropane, methyl nonafluorobutyl ether, methoxy-nonafluorobutane, ethoxy-nonafluorobutane, dodecafluoro-2-methylpentan-3-one, 1,1,1,2,2,3,4,5,5,5-decafluoro-3-methoxy-4-(trifluoromethyl)-pentane, siloxanes, methyl perfluoroheptene ether, MPPE, perfluorohept-2-ene/perfluorohept-3-ene, PFH mixture, Perfluorohept-1-ene, 1-bromo-1,2,3,3,3-pentafluoropropene, 2-bromo-1,1,1,3,3-pentafluoro-2-propene, (E)-1-Bromo-2,3,3,3-tetrafluoropropene, (Z)-1-Bromo-2,3,3,3-tetrafluoropropene, 2-bromo-3,3,3-trifluoro-propene, trans-DCE/R-1336mzz(Z) mixtures, trans-DCE/methylperfluoroheptene ethers, trans-DCE/HFC-43-10mee mixtures, 2-bromo-2-chloro-1,1,1-trifluoroethane, 2,3-dichloro-3,3-difluoropropene, (E)-1,4,4-tetrafluoro-2-butene, 2-bromo-1,1-difluoroethane, 1-chloro-2,3,3,4,4,4-hexafluoro-1-butene, 1-chloro-2,3,3-trifluoropropene, 2-(1,1,2,2-tetrafluoroethoxy)-1-fluoroethylene, 2,3,3,3-tetrafluoro-1-(1,1,2,2-tetrafluoroethoxy)prop-1-ene, 1-(difluoromethoxy)-2,3,3,3-tetrafluoroprop-1-ene, 2,3,3-trifluoro-1-(trifluoromethoxy)prop-1-ene, 1,1,1,2,2,5,5,6,6,6-decafluoro-3-hexene, 1,1,1,2,2,3,3,4,4,7,7,8,8,9,9,10,10,10-octadecafluoro-5-decene, or 1,1,1,2,3,4,4,5,5,5-decafluoropentane.

5. The process of claim 4, wherein the compound of formula (3) includes 1,1,1,2,2,5,5,6,6,7,7,7-dodecafluorohept-2-ene.

6. The process of claim 5, wherein the co-compound includes
at least one of HFO-1336mzz(E), HFO-1336mzz(Z), HFO-1234ze(Z), HFO-1234ye(E), HFO-1234ye(Z), or ethanol.

7. A process for treating a surface, comprising:
providing a surface;
contacting the surface with a treatment composition;
wherein the surface includes a treatable material deposited thereon; and
wherein the treatment composition comprises a composition comprising 1,1,1,2,2,5,5,6,6,7,7,7-dodecafluorohept-2-ene; and, optionally,
at least one of (E)-1,1,1,4,4,4-hexafluoro-2-butene, (Z)-1,1,1,4,4,4-hexafluoro-2-butene, (E)-2,3-bis(trifluoromethyl)oxirane, (Z)-2,3-bis(trifluoromethyl)oxirane, HFO-1234ze(Z), HFO-1234ye(E), HFO-1234ye(Z), HFO-1438mzz(E), HFO-1438mzz(Z), Heptafluoro-4-(trifluoromethyl)-pent-2-ene, HFO-162-13mcyz, HFO-162-13mczy, (E)-1,3,4,4,4-pentafluoro-3-(trifluoromethyl)-1-butene, (Z)-1,3,4,4,4-pentafluoro-3-(trifluoromethyl)-1-butene, HFO-1336ze(E), HFO-1336ze(Z), HFC-245fa, HFC-245ea, HFC-365mfc, (E)-1-chloro-3,3,3-trifluoro-propene, (Z)-1-chloro-3,3,3-trifluoro-propene, HCFO-1224yd(E), HCFO-1224yd(Z), iso-pentane, n-pentane, cyclo-pentane, n-hexane, cyclohexane, heptane, methyl formate, dimethoxymethane, dimethoxyethane, propanal, methanol, ethanol, isopropanol, n-propanol, trans-1,2-dichloro-ethylene, cis-1,2 dichloro-ethylene, 1-methoxyheptafluoropropane, methyl nonafluorobutyl ether, methoxy-nonafluorobutane, ethoxy-nonafluorobutane, dodecafluoro-2-methylpentan-3-one, 1,1,1,2,2,3,4,5,5,5-decafluoro-3-methoxy-4-(trifluoromethyl)-pentane, siloxanes, methyl perfluoroheptene ether, MPPE, perfluorohept-2-ene/perfluorohept-3-ene, PFH mixture, Perfluorohept-1-ene, 1-bromo-1,2,3,3,3-pentafluoropropene, 2-bromo-1,1,1,3,3-pentafluoro-2-propene, (E)-1-Bromo-2,3,3,3-tetrafluoropropene, (Z)-1-Bromo-2,3,3,3-tetrafluoropropene, 2-bromo-3,3,3-trifluoro-propene, 1336mzz(Z) mixtures, trans-DCE/methylperfluoroheptene ethers, trans-DCE/HFC-43-10mee mixtures, 2-bromo-2-chloro-1,1,1-trifluoroethane, 2,3-dichloro-3,3-difluoropropene, (E)-1,1,4,4-tetrafluoro-2-butene, 2-bromo-1,1-difluoroethane, 1-chloro-2,3,3,4,4,4-hexafluoro-1-butene, 1-chloro-2,3,3-trifluoropropene, 2-(1,1,2,2-tetrafluoroethoxy)-1-fluoroethylene, 2,3,3,3-tetrafluoro-1-(1,1,2,2-tetrafluoroethoxy)prop-1-ene, 1-(difluoromethoxy)-2,3,3,3-tetrafluoroprop-1-ene, 2,3,3-trifluoro-1-(trifluoromethoxy)prop-1-ene, 1,1,1,2,2,5,5,6,6,6-decafluoro-3-hexene, 1,1,1,2,2,3,3,4,4,7,7,8,8,9,9,10,10,10-octadecafluoro-5-decene, or 1,1,1,2,3,4,4,5,5,5-decafluoropentane.

8. A cooling, heating or power generation system, comprising:
an evaporator,
a condenser;
a compressor;
an expansion device; and
a heat transfer media;
wherein the heat transfer media comprises a composition comprising C₃F₇CH═CHC₂F₅; and, optionally,
at least one of (E)-1,1,1,4,4,4-hexafluoro-2-butene, (Z)-1,1,1,4,4,4-hexafluoro-2-butene, (E)-2,3-bis(trifluoromethyl)oxirane, (Z)-2,3-bis(trifluoromethyl)oxirane, HFO-1234ze(Z), HFO-1234ye(E), HFO-1234ye(Z), HFO-1438mzz(E), HFO-1438mzz(Z), Heptafluoro-4-(trifluoromethyl)-pent-2-ene, HFO-162-13mcyz, HFO-162-13mczy, (E)-1,3,4,4,4-pentafluoro-3-(trifluoromethyl)-1-butene, (Z)-1,3,4,4,4-pentafluoro-3-(trifluoromethyl)-1-butene, HFO-1336ze(E), HFO-1336ze(Z), HFC-245fa, HFC-245ea, HFC-365mfc, (E)-1-chloro-3,3,3-trifluoro-propene, (Z)-1-chloro-3,3,3-trifluoro-propene, HCFO-1224yd(E), HCFO-1224yd(Z), iso-pentane, n-pentane, cyclo-pentane, n-hexane, cyclohexane, heptane, methyl formate, dimethoxymethane, dimethoxyethane, propanal, methanol, ethanol, isopropanol, n-propanol, trans-1,2-dichloro-ethylene, cis-1,2 dichloro-ethylene, 1-methoxyheptafluoropropane, methyl nonafluorobutyl ether, methoxy-nonafluorobutane, ethoxy-nonafluorobutane, dodecafluoro-2-methylpentan-3-one, 1,1,1,2,2,3,4,5,5,5-decafluoro-3-methoxy-4-(trifluoromethyl)-pentane, siloxanes, methyl perfluoroheptene ether, MPPE, perfluorohept-2-ene/perfluorohept-3-ene, PFH mixture, Perfluorohept-1-ene, 1-bromo-1,2,3,3,3-pentafluoropropene, 2-bromo-1,1,1,3,3-pentafluoro-2-propene, (E)-1-Bromo-2,3,3,3-tetrafluoropropene, (Z)-1-Bromo-2,3,3,3-tetrafluoropropene, 2-bromo-3,3,3-trifluoro-propene, trans-DCE/R-1336mzz(Z) mixtures, trans-DCE/methylperfluoroheptene ethers, trans-DCE/HFC-43-10mee mixtures, 2-bromo-2-chloro-1,1,1-trifluoroethane, 2,3-dichloro-3,3-difluoropropene, (E)-1,1,4,4-tetrafluoro-2-butene, 2-bromo-1,1-difluoroethane, 1-chloro-2,3,3,4,4,4-hexafluoro-1-butene, 1-chloro-2,3,3-trifluoropropene, 2-(1,1,2,2-tetrafluoroethoxy)-1-fluoroethylene, 2,3,3,3-tetrafluoro-1-(1,1,2,2-tetrafluoroethoxy)prop-1-ene, 1-(difluoromethoxy)-2,3,3,3-tetrafluoroprop-1-ene, 2,3,3-trifluoro-1-(trifluoromethoxy)prop-1-ene, 1,1,1,2,2,5,5,6,6,6-decafluoro-3-hexene, 1,1,1,2,2,3,3,4,4,7,7,8,8,9,9,10,10,10-octadecafluoro-5-decene, or 1,1,1,2,3,4,4,5,5,5-decafluoropentane.

9. The system of claim 8, where the condenser is operated at a temperature higher than 100° C.

10. A heat pipe system comprising:
a heat pipe having a working fluid therein;
wherein the working fluid comprises a composition comprising C₃F₇CH═CHC₂F₅; and, optionally,
at least one of (E)-1,1,1,4,4,4-hexafluoro-2-butene, (Z)-1,1,1,4,4,4-hexafluoro-2-butene, (E)-2,3-bis(trifluoromethyl)oxirane, (Z)-2,3-bis(trifluoromethyl)oxirane, HFO-1234ze(Z), HFO-1234ye(E), HFO-1234ye(Z), HFO-1438mzz(E), HFO-1438mzz(Z), Heptafluoro-4-(trifluoromethyl)-pent-2-ene, HFO-162-13mcyz, HFO-162-13mczy, (E)-1,3,4,4,4-pentafluoro-3-(trifluoromethyl)-1-butene, (Z)-1,3,4,4,4-pentafluoro-3-(trifluoromethyl)-1-butene, HFO-1336ze(E), HFO-1336ze(Z), HFC-245fa, HFC-245ea, HFC-365mfc, (E)-1-chloro-3,3,3-trifluoro-propene, (Z)-1-chloro-3,3,3-trifluoro-propene, HCFO-1224yd(E), HCFO-1224yd(Z), iso-pentane, n-pentane, cyclo-pentane, n-hexane, cyclohexane, heptane, methyl formate, dimethoxymethane, dimethoxyethane, propanal, methanol, ethanol, isopropanol, n-propanol, trans-1,2-dichloro-ethylene, cis-1,2 dichloro-ethylene, 1-methoxyheptafluoropropane, methyl nonafluorobutyl ether, methoxy-nonafluorobutane, ethoxy-nonafluorobutane, dodecafluoro-2-methylpentan-3-one, 1,1,1,2,2,3,4,5,5,5-decafluoro-3-methoxy-4-(trifluoromethyl)-pentane, siloxanes, methyl perfluoroheptene ether, methoxy-perfluoro heptene ether or MPHE (HFX-110; C₇F₁₃(OCH₃)), MPPE (HFX-75), perfluorohept-2-ene/perfluorohept-3-ene (HFO-161-14myy/HFO-161-14mcyy, PFH mixture, CF₃CF═CFCF₂CF₂CF₂CF₃/CF₃CF₂CF═CFCF₂CF₂CF₃), Perfluorohept-1-ene (FC-141-10cy, CF₂═CFCF₂CF₂CF₂CF₂CF₃), 1-bromo-1,2,3,3,3-pentafluoropropene, 2-bromo-1,1,1,3,3-pentafluoro-2-propene, (E)-1-Bromo-2,3,3,3-tetrafluoropropene, (Z)-1-Bromo-2,3,3,3-tetrafluoropropene, 2-bromo-3,3,3-trifluoro-propene, trans-DCE/R-1336mzz(Z) mixtures, trans-DCE/methylperfluoroheptene ethers, trans-DCE/HFC-43-10mee mixtures, 2-bromo-2-chloro-1,1,1-trifluoroethane, 2,3-dichloro-3,3-difluoropropene, (E)-1,4,4-tetrafluoro-2-butene, 2-bromo-1,1-difluoroethane, 1-chloro-2,3,3,4,4,4-hexafluoro-1-butene, 1-chloro-2,3,3-trifluoropropene, 2-(1,1,2,2-tetrafluoroethoxy)-1-fluoroethylene, 2,3,3,3-tetrafluoro-1-(1,1,2,2-tetrafluoroethoxy)prop-1-ene, 1-(difluoromethoxy)-2,3,3,3-tetrafluoroprop-1-ene, 2,3,3-trifluoro-1-(trifluoromethoxy)prop-1-ene, 1,1,1,2,2,5,5,6,6,6-decafluoro-3-hexene, 1,1,1,2,2,3,3,4,4,7,7,8,8,9,9,10,10,10-octadecafluoro-5-decene, or 1,1,1,2,3,4,4,5,5,5-decafluoropentane.

11. A process for recovering heat from a heat source and generating mechanical energy, comprising the steps of:
(a) passing a first working fluid in liquid phase through a heat exchanger or an evaporator, wherein said heat exchanger or said evaporator is in communication with said heat source that supplies said heat,
(b) removing at least a portion of said first working fluid in a vapor phase from said heat exchanger or said evaporator;
(c) passing said at least a portion of said first working fluid in vapor phase to an expander, wherein at least portion of said heat is converted into mechanical energy;
(d) passing said at least a portion of said first working fluid in vapor phase from said expander to a condenser, wherein said at least a portion of said first working fluid in vapor phase is condensed to a second working fluid in liquid phase;
(e) optionally, compressing and mixing said second working fluid in liquid phase with said first working fluid in liquid phase in Step (a); and
(f) optionally, repeating Steps (a) through (e), at least one time;
wherein at least one of the first working fluid or the second working fluid comprises a composition comprising a compound of formula (4),
R_{f}CF₃(CX₅X₆CX₇X₈)ₙCH═CHCX₉X₁₀CX₁₁X₁₂F (4)
wherein R_{f} is a C₁-C₁₀ perfluorinated alkyl group;
wherein X₅, X₆, X₇, X₈, X₉, X₁₀, X₁₁, and X₁₂ are each independently H, Cl, or F, n is an integer of 0 or 1; and
wherein the total number of F represented by X₅, X₆, X₇, X₈, X₉, X₁₀, X₁₁, and X₁₂ is at least two; and, optionally,
a co-compound including at least one of (E)-1,1,1,4,4,4-hexafluoro-2-butene, (Z)-1,1,1,4,4,4-hexafluoro-2-butene, (E)-2,3-bis(trifluoromethyl)oxirane, (Z)-2,3-bis(trifluoromethyl)oxirane, HFO-1234ze(Z), HFO-1234ye(E), HFO-1234ye(Z), HFO-1438mzz(E), HFO-1438mzz(Z), Heptafluoro-4-(trifluoromethyl)-pent-2-ene, HFO-162-13mcyz, HFO-162-13mczy, (E)-1,3,4,4,4-pentafluoro-3-(trifluoromethyl)-1-butene, (Z)-1,3,4,4,4-pentafluoro-3-(trifluoromethyl)-1-butene, HFO-1336ze(E), HFO-1336ze(Z), HFC-245fa, HFC-245ea, HFC-365mfc, (E)-1-chloro-3,3,3-trifluoro-propene, (Z)-1-chloro-3,3,3-trifluoro-propene, HCFO-1224yd(E), HCFO-1224yd(Z), iso-pentane, n-pentane, cyclo-pentane, n-hexane, cyclohexane, heptane, methyl formate, dimethoxymethane, dimethoxyethane, propanal, methanol, ethanol, isopropanol, n-propanol, trans-1,2-dichloro-ethylene, cis-1,2 dichloro-ethylene, 1-methoxyheptafluoropropane, methyl nonafluorobutyl ether, methoxy-nonafluorobutane, ethoxy-nonafluorobutane, dodecafluoro-2-methylpentan-3-one, 1,1,1,2,2,3,4,5,5,5-decafluoro-3-methoxy-4-(trifluoromethyl)-pentane, siloxanes, methyl perfluoroheptene ether, methoxy-perfluoro heptene ether or MPHE (HFX-110; C₇F₁₃(OCH₃)), MPPE (HFX-75), perfluorohept-2-ene/perfluorohept-3-ene (HFO-161-14myy/HFO-161-14mcyy, PFH mixture, CF₃CF═CFCF₂CF₂CF₂CF₃/CF₃CF₂CF═CFCF₂CF₂CF₃), Perfluorohept-1-ene (FC-141-10cy, CF₂═CFCF₂CF₂CF₂CF₂CF₃), 1-bromo-1,2,3,3,3-pentafluoropropene, 2-bromo-1,1,1,3,3-pentafluoro-2-propene, (E)-1-Bromo-2,3,3,3-tetrafluoropropene, (Z)-1-Bromo-2,3,3,3-tetrafluoropropene, 2-bromo-3,3,3-trifluoro-propene, trans-DCE/R-1336mzz(Z) mixtures, trans-DCE/methylperfluoroheptene ethers, trans-DCE/HFC-43-10mee mixtures, 2-bromo-2-chloro-1,1,1-trifluoroethane, 2,3-dichloro-3,3-difluoropropene, (E)-1,1,4,4-tetrafluoro-2-butene, 2-bromo-1,1-difluoroethane, 1-chloro-2,3,3,4,4,4-hexafluoro-1-butene, 1-chloro-2,3,3-trifluoropropene, 2-(1,1,2,2-tetrafluoroethoxy)-1-fluoroethylene, 2,3,3,3-tetrafluoro-1-(1,1,2,2-tetrafluoroethoxy)prop-1-ene, 1-(difluoromethoxy)-2,3,3,3-tetrafluoroprop-1-ene, 2,3,3-trifluoro-1-(trifluoromethoxy)prop-1-ene, 1,1,1,2,2,5,5,6,6,6-decafluoro-3-hexene, 1,1,1,2,2,3,3,4,4,7,7,8,8,9,9,10,10,10-octadecafluoro-5-decene, or 1,1,1,2,3,4,4,5,5,5-decafluoropentane.

12. A high temperature heat pump apparatus, said apparatus comprising (a) a first heat exchanger through which a working fluid flows and is heated; (b) a compressor in fluid communication with the first heat exchanger that compresses the heated working fluid to a higher pressure; (c) a second heat exchanger in fluid communication with the compressor through which the high pressure working fluid flows and is cooled; and (d) a pressure reduction device in fluid communication with the second heat exchanger wherein the pressure of the cooled working fluid is reduced and said pressure reduction device further being in fluid communication with the evaporator such that the working fluid then repeats flow through components (a), (b), (c) and (d) in a repeating cycle.

13. The high temperature heat pump apparatus of claim 12 wherein at least one of the first working fluid or the second working fluid comprises a composition comprising a compound of formula (4),
R_{f}CF₃(CX₅X₆CX₇X₈)ₙCH═CHCX₉X₁₀CX₁₁X₁₂F (4)
wherein R_{f} is a C₁-C₁₀ perfluorinated alkyl group;
wherein X₅, X₆, X₇, X₈, X₉, X₁₀, X₁₁, and X₁₂ are each independently H, Cl, or F, n is an integer of 0 or 1; and
wherein the total number of F represented by X₅, X₆, X₇, X₈, X₉, X₁₀, X₁₁, and X₁₂ is at least two; and, optionally,
a co-compound including at least one of (E)-1,1,1,4,4,4-hexafluoro-2-butene, (Z)-1,1,1,4,4,4-hexafluoro-2-butene, (E)-2,3-bis(trifluoromethyl)oxirane, (Z)-2,3-bis(trifluoromethyl)oxirane, HFO-1234ze(Z), HFO-1234ye(E), HFO-1234ye(Z), HFO-1438mzz(E), HFO-1438mzz(Z), Heptafluoro-4-(trifluoromethyl)-pent-2-ene, HFO-162-13mcyz, HFO-162-13mczy, (E)-1,3,4,4,4-pentafluoro-3-(trifluoromethyl)-1-butene, (Z)-1,3,4,4,4-pentafluoro-3-(trifluoromethyl)-1-butene, HFO-1336ze(E), HFO-1336ze(Z), HFC-245fa, HFC-245ea, HFC-365mfc, (E)-1-chloro-3,3,3-trifluoro-propene, (Z)-1-chloro-3,3,3-trifluoro-propene, HCFO-1224yd(E), HCFO-1224yd(Z), iso-pentane, n-pentane, cyclo-pentane, n-hexane, cyclohexane, heptane, methyl formate, dimethoxymethane, dimethoxyethane, propanal, methanol, ethanol, isopropanol, n-propanol, trans-1,2-dichloro-ethylene, cis-1,2 dichloro-ethylene, 1-methoxyheptafluoropropane, methyl nonafluorobutyl ether, methoxy-nonafluorobutane, ethoxy-nonafluorobutane, dodecafluoro-2-methylpentan-3-one, 1,1,1,2,2,3,4,5,5,5-decafluoro-3-methoxy-4-(trifluoromethyl)-pentane, siloxanes, methyl perfluoroheptene ether, methoxy-perfluoro heptene ether or MPHE (HFX-110; C₇F₁₃(OCH₃)), MPPE (HFX-75), perfluorohept-2-ene/perfluorohept-3-ene (HFO-161-14myy/HFO-161-14mcyy, PFH mixture, CF₃CF═CFCF₂CF₂CF₂CF₃/CF₃CF₂CF═CFCF₂CF₂CF₃), Perfluorohept-1-ene (FC-141-10cy, CF₂═CFCF₂CF₂CF₂CF₂CF₃), 1-bromo-1,2,3,3,3-pentafluoropropene, 2-bromo-1,1,1,3,3-pentafluoro-2-propene, (E)-1-Bromo-2,3,3,3-tetrafluoropropene, (Z)-1-Bromo-2,3,3,3-tetrafluoropropene, 2-bromo-3,3,3-trifluoro-propene, trans-DCE/R-1336mzz(Z) mixtures, trans-DCE/methylperfluoroheptene ethers, trans-DCE/HFC-43-10mee mixtures, 2-bromo-2-chloro-1,1,1-trifluoroethane, 2,3-dichloro-3,3-difluoropropene, (E)-1,1,4,4-tetrafluoro-2-butene, 2-bromo-1,1-difluoroethane, 1-chloro-2,3,3,4,4,4-hexafluoro-1-butene, 1-chloro-2,3,3-trifluoropropene, 2-(1,1,2,2-tetrafluoroethoxy)-1-fluoroethylene, 2,3,3,3-tetrafluoro-1-(1,1,2,2-tetrafluoroethoxy)prop-1-ene, 1-(difluoromethoxy)-2,3,3,3-tetrafluoroprop-1-ene, 2,3,3-trifluoro-1-(trifluoromethoxy)prop-1-ene, 1,1,1,2,2,5,5,6,6,6-decafluoro-3-hexene, 1,1,1,2,2,3,3,4,4,7,7,8,8,9,9,10,10,10-octadecafluoro-5-decene, or 1,1,1,2,3,4,4,5,5,5-decafluoropentane.
